(19) United States
(12) Patent Application Publication
(10) Pub. No.: US 2025/0323523 A1
(43) Pub. Date: Oct. 16, 2025

(54) System and Method for Controlling an Operation of an Electric Grid

(71) Applicant: Mitsubishi Electric Research Laboratories, Inc., Cambridge, MA (US)

(72) Inventor: Arvind Raghunathan, Cambridge, MA (US)

(73) Assignee: Mitsubishi Electric Research Laboratories, Inc., Cambridge, MA (US)

(21) Appl. No.: 18/815,895

(22) Filed: Aug. 27, 2024

Related U.S. Application Data
(60) Provisional application No. 63/633,631, filed on Apr. 12, 2024.

(51) Int. Cl. H02J 13/00; H02J 3/00

(52) U.S. Cl. CPC H02J 13/00002; H02J 3/00

(57) ABSTRACT

The electric grid is controlled by formulating an original quadratic program (QP) for optimizing an objective function subject to equality constraints and inequality constraints, lifting the equality constraints and the inequality constraints into a lifted space by a lifting operation introducing an additional non-negative variable, and transforming the objective function of the original QP into a quadratic objective function. The quadratic objective function subject to the lifted equality and inequality constraints forms a homogeneous QP in the lifted space solved to produce a solution in the lifted space using a decomposition that replaces variables corresponding to individual generators with dual variables corresponding to the total demand of power, the additional nonnegative variable and its corresponding dual variable. That solution is transformed to a control command for controlling the electric grid.

### TECHNICAL FIELD

The present disclosure relates generally to electric grid control, and more particularly to a system and a method for controlling an operation of an electric grid.

### BACKGROUND

In day-to-day life, electric grids play a pivotal role in distributing electricity from power plants to various consumers. The various consumers may consume the electricity in homes, buildings, facilities, and industries from various operations. The various operations include but are not limited to, heating operations, lighting operations, cooling operations, ventilation operations, transportation operations, and communication operations. The electric grids comprise a plurality of generators, transmission lines, substations, distribution lines, transformers and distribution systems that distribute the electricity from the power plants to the various consumers.

However, fluctuations in load demand or power generation can lead to instability in the operations of the electric grids. Additionally, the integration of distributed energy resources such as solar photovoltaic systems, wind turbines, and energy storage devices for power generation increases the complexity of operations of the electric grids. The distributed energy resources may generate variable output, thereby further instability in the operations of the electric grids. Hence, to ensure the stability of the electric grids, there is a need to control the plurality of generators to maintain a balance between the power generation and the demand in real-time. Additionally, it is desirable to minimize a cost of operations associated with the plurality of generators.

To that end, a quadratic program can be formulated to minimize the cost of operations associated with the plurality of generators. The quadratic program is a process of solving certain mathematical optimization problems involving quadratic functions. Specifically, the quadratic program involves optimizing (minimize or maximize) a multivariate quadratic function subject to constraints on variables. Quadratic programming arises as sub problems when solving nonlinear programming. The quadratic program is widely used for optimization-based control and estimation methods, such as model predictive control (MPC) and moving horizon estimation (MHE). One of the main advantages of these methods is their systematic way of incorporating a dynamic model of a system, limitations in form of inequality constraints, and performance metrics in form of a cost function.

At each sampling instant, a model-based predictive controller or estimator solves a multi-stage dynamic optimization problem that minimizes a particular cost function subject to a discrete-time description of the system dynamics and the inequality constraints. A block-sparse quadratic program structure arises in linear or linear time-varying formulations of predictive control and estimation. A similarly structured QP forms sub problems within a sequential quadratic programming (SQP) method for nonlinear optimal control.

To that end, a number of methods have been developed to solve the quadratic program. Examples of the methods for solving the quadratic program include an interior point method, an active set method, an augmented Lagrangian method, and a conjugate gradient or gradient projection method. However, the quadratic program is difficult to solve due to its potential non-convexity and the constraints. To address such a problem, a number of methods reformulate the quadratic program into a different space and solve the reformulated quadratic program. For example, the augmented Lagrangian method solves Lagrangian dual of the quadratic program.

However, while the reformulation of the quadratic program may address some difficulties, another complication still exists, viz, the quadratic program may not have a feasible solution at all. The infeasibility can be caused by due to operating constraints associated with the plurality of generators. Examples of the operating constraints include but are not limited to power constraints, ramp-up constraints, and ramp-down constraints. Additionally, a direct computation of the reformulated QP leads to an increase in a computational complexity of computing a control step at each iteration with an increase in a number of generators of the plurality of generators. The increased computational complexity may lead to computationally prohibitive operations for the electric grid. In an example embodiment, the increased computational complexity corresponds to a cubic computational complexity that scales cubically with the increase in number of generators of the plurality of generators.

Accordingly, there is a need for a system and a method to decrease the computation complexity associated with the computation of the re-formulated QP.

### i. SUMMARY

It is an object of some embodiments to provide a system and a method to detect infeasibility of an original quadratic program (QP). Some embodiments are based on an object to formulate the original QP based on a current state of an operation of the electric grid and a total demand of power from a plurality of generators of the electric grid. The original QP optimizes an objective function subject to constraints. The constraints may include equality constraints and inequality constraints. Additionally or alternatively, it is object of some embodiments to provide such a system and a method that can determine a solution of the original QP based on a determination that the original QP is feasible. Additionally, it is object of some embodiments to determine a control command based on the solution of the original QP, and control the electric grid machine based on the determined control command.

Some embodiments are based on an understanding that original QP can be reformulated into a different space to address problems such as non-convexity of the original QP and the constraints. The reformulation ensures that each set defined by the constraints intersect at least at one point. Further, some embodiments are based on a recognition that that the original QP is infeasible based on a determination of an optimal solution of the QP at that point. In this approach the infeasibility is detected based on a convergence of iteration rather than using conventional approach of divergence of iteration. The feasibility detection based on the convergence of iteration is more efficient and computationally cheaper.

Some embodiments are based on an objective to lift the inequality constraints and the equality constraints into a lifted space having a dimension higher than a dimension of an original space of the original QP by a lifting operation. The lifting operation introduces an additional non-negative variable such that a subspace defined by the equality constraint in the lifted space intersects a subspace defined by the inequality constraint in the lifted space at least at a point of origin of the lifted space. In such a manner, the infeasibility of the original QP can be detected when the solution of the QP in the lifted space has the value of the additional non-negative variable equal to zero.

Different lifting operations can be used to transform the constraints from the original space into the lifted space of higher dimensions. Examples of the lifting operations include multiplication of the constraints with one or multiple additional variables defining new dimensions, affine or non-affine transformations of the constraints, and the like.

Some embodiments select such a lifting operation that has a corresponding projection operation that reverses the effects of the lifting operation. For example, if the lifting operation includes multiplication of values in the original space with the additional non-negative variable, the projecting operation includes dividing values in the lifted space by the additional non-negative variable. Similarly, when the lifting operation includes addition of values in the original space by the additional non-negative variable, the projecting operation includes subtraction of the additional non-negative variable from the values in the lifted space.

Some embodiments are based on the recognition that in order to use the constraints in the lifted space, there is a need to transform the original QP from the original space to the lifted space. However, the lifting operation used for lifting the constraints is not directly applicable for lifting the objective function of the original QP since the objective function has quadratic terms and linear terms. Multiplying the quadratic terms by the additional non-negative variable results in an objective function that is a degree 3 polynomial and no longer a quadratic program. In other words, direct application of the lifting operation to the original QP is not possible.

However, some embodiments are based on a realization that regardless of structure of the original QP lifted in the lifted space, a relationship between the optimal solution in the original space and the optimal solution in the lifted space is governed by the lifting operation. Further, the optimal solutions, while unknown, should satisfy first-order optimality conditions. Moreover, the lifting operation for the constraints, while not applicable to the QP objective function, is applicable to the first-order optimality conditions.

To that end, some embodiments, after lifting the constraints into the lifted space with the lifting operation, transform the objective function of the original QP in the original space into a quadratic objective function involving variables of the original QP and the additional non-negative variable. The quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation.

Further, the homogeneous QP is solved to produce a solution in the lifted space. If the value of the additional non-negative variable in the solution in the lifted space equals to zero, then, the machine is controlled according to an infeasibility protocol. If the value of the additional non-negative variable in the solution in the lifted space is not equal to zero, then, the solution in the lifted space is projected into the original space using a projection operation reversing the lifting operation, to produce a solution of the original QP. For example, if the equality constraints are lifted in the lifted space by scaling the equality constraints with the additional non-negative variable, then the solution in the lifted space is projected to the original space by dividing the solution in the lifted space with the additional non-negative variable.

Further, in some embodiments, a control command is determined based on the solution of the original QP. Further, the electric grid is controlled based on the control command determined based on the solution of the original QP.

Different embodiments use different formulations of the homogeneous QP. Any formulation of the homogeneous QP is valid as long as the first-order optimality conditions of the homogeneous QP correspond to the first-order optimality conditions of the original QP lifted in the higher space by the lifting operation. However, some embodiments can impose additional rules on the formulation of the homogeneous QP for different computational and optimization reasons. For example, in one embodiment, the original QP is transformed such that the solution of the homogeneous QP in the lifted space is negative for positive values of the additional non-negative variable. This rule ensures that the optimal value in the lifted space for the feasible original QP problem does not have the value of the additional non-negative variable equal to zero.

Some embodiments are based on a realization that the computational complexity of computing the step at each iteration of the optimization problem scales cubically with number of generators. Additionally, a variable output from one or more renewable resources may further increase the computational complexity of computing the step at each iteration of the optimization problem.

Hence, some embodiments are based on an objective to employ a decomposition method to perform a decomposition of the step computation in the optimization algorithm. The decomposition method allows for computing of the search direction in computational complexity that is linear in the number of generators such that cost of computation scales linearly in the number of generators. Additionally or alternatively, the decomposition can be performed in conjunction with the reformulation of the optimization problem to efficiently determine the optimal solution of the homogeneous QP.

Accordingly, one embodiment discloses a controller for controlling an operation of an electric grid including a plurality of generators. The controller comprises a memory configured to store executable instructions, and a processor configured to execute the executable instructions to cause the controller to: collect a feedback signal indicative of a current state of the operation of the electric grid and a total demand of power from the plurality of generators of the electric grid; formulate an original quadratic program (QP) for optimizing an objective function subject to equality constraints and inequality constraints on one or a combination of state and control variables of the machine based on the task and the current state of the operation of the machine; lift the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space; transform the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation; solve the homogeneous QP to produce a solution in the lifted space using a decomposition method; control the machine according to an infeasibility protocol when a value of the additional non-negative variable in the solution in the lifted space equals zero; and otherwise project the solution in the lifted space into the original space using a projection operation reversing the lifting operation to produce a solution of the original QP; and control the electric grid using a control command determined based on the solution of the original QP.

Accordingly, another embodiment discloses a method for controlling an operation of an electric grid including a plurality of generators. The method comprises collecting a feedback signal indicative of a current state of the operation of the electric grid and a total demand of power from the plurality of generators of the electric grid; formulating an original quadratic program (QP) for optimizing an objective function subject to equality constraints and inequality constraints on one or a combination of state and control variables of the machine based on the task and the current state of the operation of the machine; lifting the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space; transforming the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation; solving the homogeneous QP to produce a solution in the lifted space using a decomposition method; controlling the machine according to an infeasibility protocol when a value of the additional non-negative variable in the solution in the lifted space equals zero; and otherwise projecting the solution in the lifted space into the original space using a projection operation reversing the lifting operation to produce a solution of the original QP; and controlling the electric grid using a control command determined based on the solution of the original QP.

Accordingly, yet another embodiment discloses a non-transitory computer-readable storage medium embodied thereon a program executable by a processor for performing a method for controlling an operation an electric grid including a plurality of generators. The method comprises collecting a feedback signal indicative of a current state of the operation of the machine; formulating an original quadratic program (QP) for optimizing an objective function subject to equality constraints and inequality constraints on one or a combination of state and control variables of the machine based on the task and the current state of the operation of the machine; lifting the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space; transforming the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation; solving the homogeneous QP to produce a solution in the lifted space using a decomposition method; controlling the machine according to an infeasibility protocol when a value of the additional non-negative variable in the solution in the lifted space equals zero; and otherwise projecting the solution in the lifted space into the original space using a projection operation reversing the lifting operation to produce a solution of the original QP; and controlling the electric grid using a control command determined based on the solution of the original QP.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a block diagram for controlling an operation of an electric grid, according to some embodiments of the present disclosure.

FIG. 1B and FIG. 1C are graphs that collectively illustrate a lifting operation for an exemplary infeasible original quadratic program (QP), according to some embodiments of the present disclosure.

FIG. 1D illustrates a block diagram for transformation of an objective function of an original QP into a quadratic objective function, according to some embodiments of the present disclosure.

FIG. 1E illustrates a schematic of principles used by some embodiments for controlling the electric grid, according to some embodiments of the present disclosure.

FIG. 1E shows a block diagram for solving a homogeneous QP to produce a solution in a lifted space and controlling the machine based on the solution in the lifted space, according to an embodiment of the present disclosure.

FIG. 1F illustrates a flowchart of a method for solving the homogeneous QP to produce the solution of the original QP in the lifted space and controlling the electric grid based on the solution of the original QP in the lifted space, according to some embodiments of the present disclosure.

FIG. 2 illustrates a flowchart of a method for solving the homogeneous QP to produce the solution of the original QP in the lifted space and controlling the electric grid based on the solution of the original QP in the lifted space, according to some embodiments of the present disclosure.

FIG. 3 illustrates a flowchart of a method for executing an IPM method in a current iteration, according to some embodiments of the present disclosure.

FIG. 4 illustrates a flowchart of a method for applying a decomposition method, according to some embodiments of the present disclosure.

FIG. 5 illustrates an Interior Point Method algorithm for determining the solution of the homogeneous QP, according to some embodiments of the present disclosure.

FIG. 6 illustrates a flowchart of a method for solving the homogeneous QP to produce the solution of the original QP in the lifted space and controlling the electric grid based on the solution of the original QP in the lifted space, according to some embodiments of the present disclosure.

FIG. 7 illustrates a semi-smooth Newton Method (SNM) algorithm for determining the solution of the homogeneous QP, according to some embodiments of the present disclosure.

FIG. 8 is a schematic illustrating a computing device for implementing of systems and methods of the present disclosure.

FIG. 9 shows an example controller, which controls generation levels according to some embodiments.

FIG. 10 shows a block diagram of a controller according to some embodiments, which actuates a system to follow a command.

FIG. 11A shows a block diagram of a system and a method for QP based control to implement a controller that computes a control signal, given the current power level of a system and a control command according to some embodiments.

FIG. 11B shows a block diagram of a controller that solves a constrained optimal control structured homogeneous quadratic programming problem (HQP) in order to compute a control signal at each control time step, given a current state of the system and a command, according to some embodiments of the present disclosure.

FIG. 12A illustrates an approach of an interior point optimization algorithm to solve a structured homogeneous quadratic programming problem (HQP), according to some embodiments of the present disclosure.

FIG. 13A shows a block diagram of an initialization step and an iterative procedure of an interior point optimization algorithm to solve HQP in an implementation of a control system, according to some embodiments of the present disclosure.

FIG. 13B shows a block diagram of a linearized KKT system to compute a Newton-type search direction in the iterative procedure of an interior point optimization algorithm to solve HQP according to some embodiments of the present disclosure.

FIG. 13C shows a block diagram of a decomposition of a linearized KKT system to compute a Newton-type search direction according to some embodiments of the present disclosure.

FIG. 13D shows a block diagram of a decomposition of the linearized KKT system to compute a Newton-type search direction where parallel computations are realized to further reduce the computation time for the Newton step according to some embodiments of the present disclosure.

FIG. 14A illustrates an approach of a semismooth newton method algorithm to solve the structured homogeneous quadratic programming problem (HQP) according to some embodiments of the present disclosure.

FIG. 15A shows a block diagram of an initialization step and the iterative procedure of an semismooth newton method algorithm to solve HQP in an implementation of the control system according to some embodiments of the present disclosure.

FIG. 15B shows a block diagram of the linearized KKT system to compute a Newton-type search direction in the iterative procedure of an semismooth newton method algorithm to solve HQP according to some embodiments of the present disclosure.

FIG. 15C shows a block diagram of a decomposition of the linearized KKT system to compute a Newton-type search direction in the semismooth newton method algorithm according to some embodiments of the present disclosure.

FIG. 15D shows a block diagram of a decomposition of the linearized KKT system to compute a Newton-type search direction where parallel computations are realized to further reduce the computation time for the Newton step according to some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

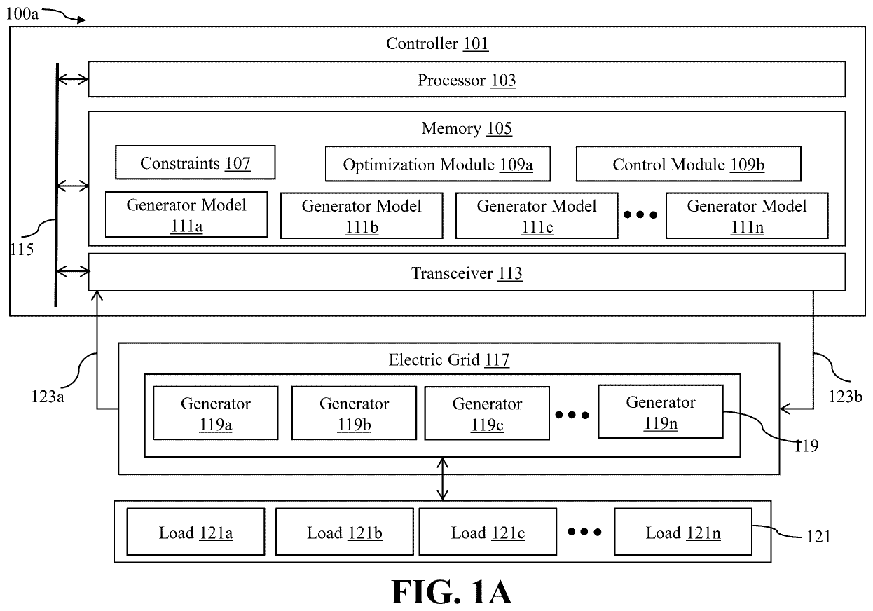

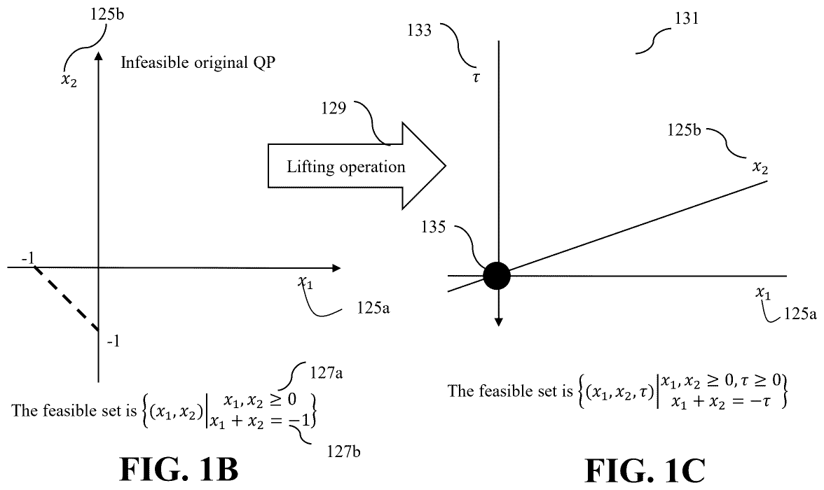

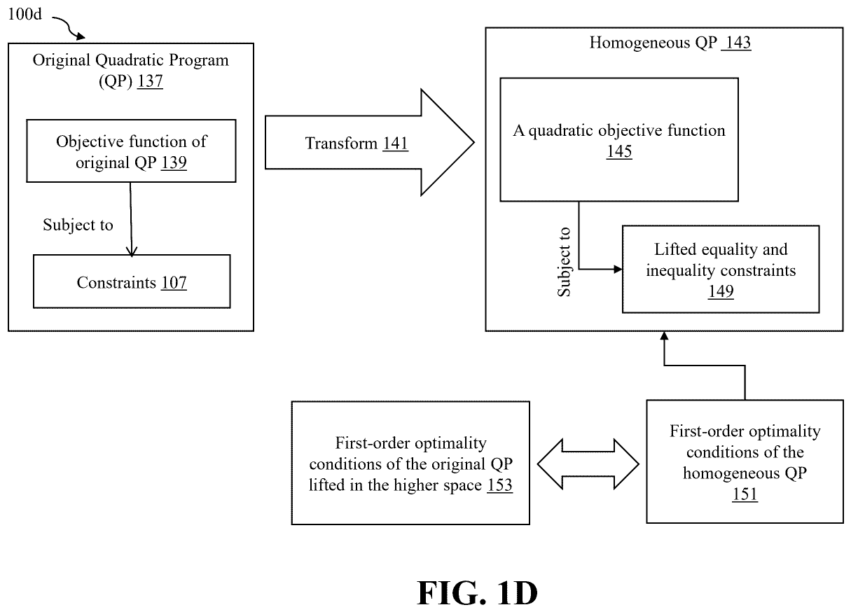

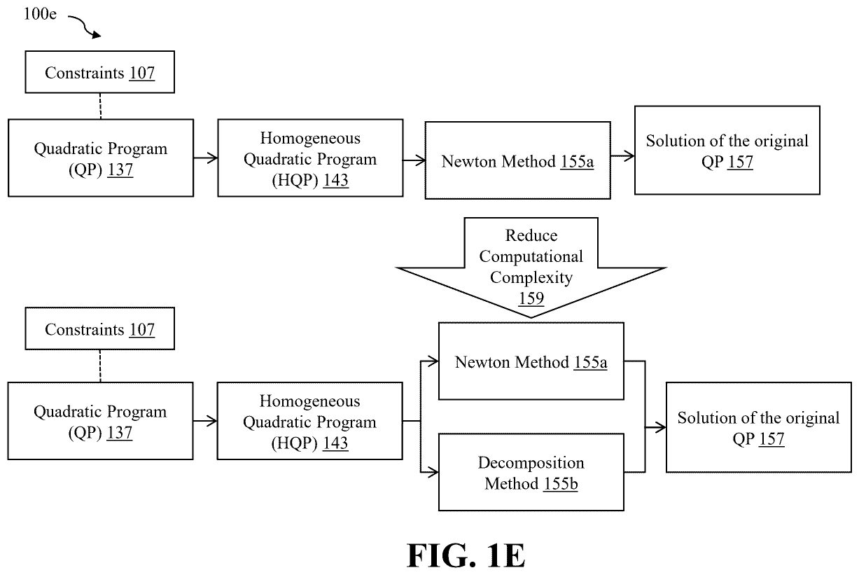

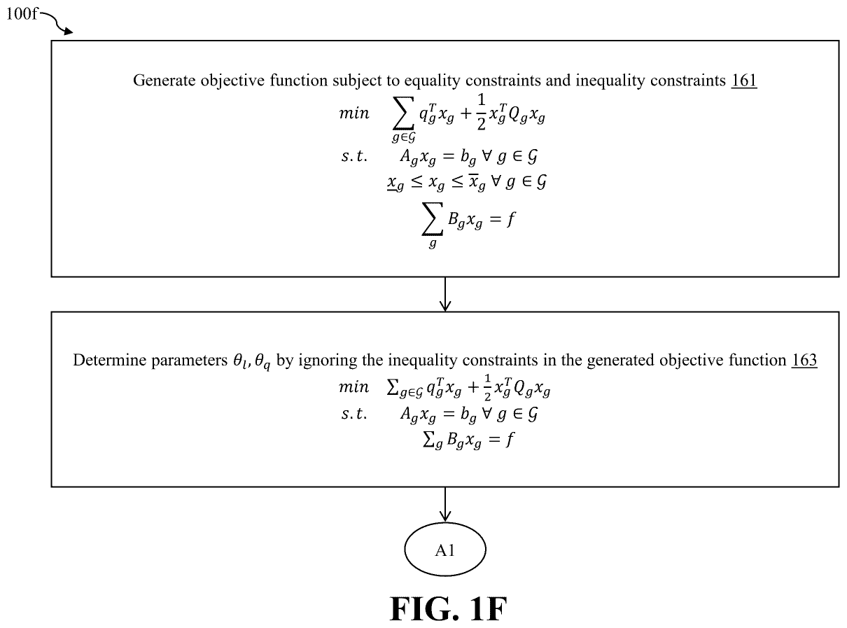

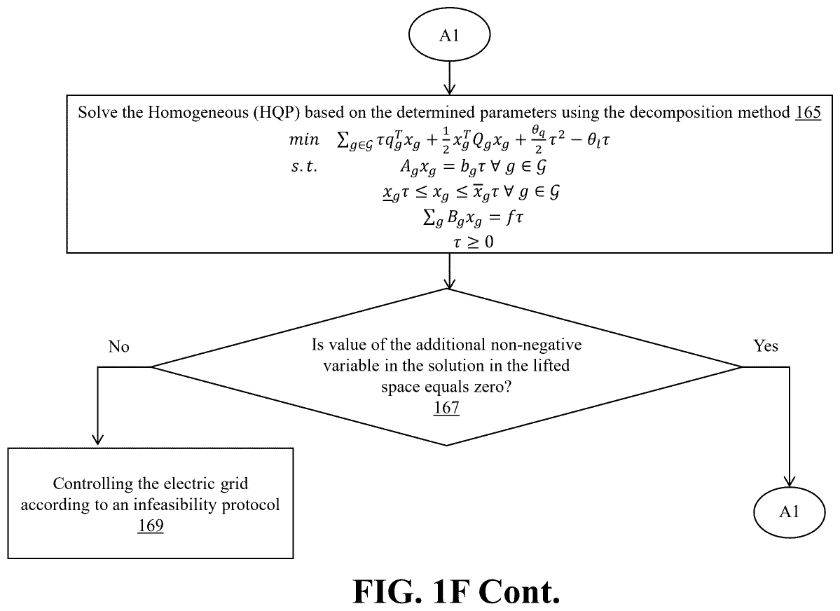

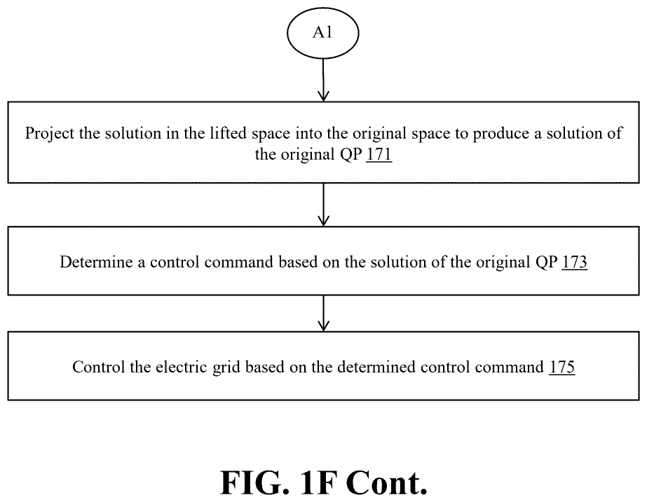

FIG. 1A illustrates a block diagram 100a for controlling an operation of an electric grid 117, according to some embodiments of the present disclosure. As shown in FIG. 1A, the controller 101 is operatively connected to the electric grid 117. The controller 101 includes a processor 103, a memory 105, a transceiver 113, and a bus 115. The memory includes constraints 107, a plurality of modules 109, and a plurality of generator models 111. The plurality of modules 109 includes an optimization module 109a, and a control module 109b. The plurality of generator models 111 includes a generator model 111a, a generator model 111b, a generator model 111c, up to a generator model 111n. The electric grid 117 includes a plurality of generators 119. The plurality of generators 119 includes a generator 119a, a generator 119b, a generator 119c, up to a generator 119n. The electric grid 117 is further operatively connected to a plurality of loads 121. The plurality of loads 121 includes a load 121a, a load 121b, a load 121c, and up to a load 121n.

In some embodiments, the controller 101 is configured to control an operation of the electric grid 115. The operation of the electric grid 115 includes, but is not limited to, a power generation operation, a power transmission operation, a power distribution operation, a power monitoring operation, a load management operation, or a combination thereof.

In some embodiment, the processor 103 is further configured to control the plurality of generators 119 to perform the power generation operation. Specifically, to perform the power generation operation, the processor 103 is further configured to control the plurality of generators 119 to produce an amount of power to satisfy a total demand of power. In some embodiments, the total demand of power is associated with the plurality of loads 121. Examples of the plurality of generators 119 include, but are not limited to, power stations, steam turbine generators, gas turbine generators, internal combustion engine generators, hydroelectric generators, wind turbine generators, solar photovoltaic generators, geothermal generators, portables generators, or a combination thereof.

In some embodiment, the processor 103 is further configured to perform the load management operation. Specifically, to perform the load management operation, the processor 103 is further configured to determine the amount power of power to satisfy the total demand of power associated with the plurality of loads 121.

In some embodiment, the processor 103 is further configured to control the plurality of generators 119 to perform the power transmission, or the power distribution operation. Specifically, to perform the power transmission, or the power distribution operation, the processor 103 is further configured to control the plurality of generators 119 to supply the produced amount of power to the plurality of loads 121. Examples of the plurality of loads 121 include, but are not limited to, residential loads, commercial loads, industrial loads, institutional loads, transportation loads, or a combination thereof.

In some embodiments, to perform the power monitoring operation, the processor 103 is further configured to collect a feedback signal 123a indicative of a current state of the operation of the electric grid 117 and the total demand of power denoted by a vector f from the plurality of generators 119 of the electric grid 117. In an embodiment, the transceiver 113 is configured to collect the feedback signal 123a from the plurality of generators 119.

In some embodiments, the memory 105 may be non-transitory and may include, for example, one or more volatile and/or non-volatile memories. In other words, for example, the memory 105 may be an electronic storage device (for example, a computer readable storage medium) comprising gates configured to store data (for example, bits) that may be retrievable by a machine (for example, a computing device like the processor 103). The memory 105 may be configured to store information, data, content, applications, instructions, or the like, for enabling the apparatus to carry out various functions in accordance with an example embodiment of the present disclosure. For example, the memory 105 may be configured to buffer input data for processing by the processor 103. As exemplarily illustrated in FIG. 1A, the memory 105 may be configured to store instructions for execution by the processor 105. As such, whether configured by hardware or software methods, or by a combination thereof, the processor 103 may represent an entity (for example, physically embodied in circuitry) capable of performing operations according to an embodiment of the present disclosure while configured accordingly. Thus, for example, when the processor 103 is embodied as an ASIC, FPGA or the like, the processor 103 may be specifically configured hardware for conducting the operations described herein.

Further, each generator model of the plurality of generator models 111 correspond to a set of mathematical equation that indicate a change in a power output of a respective generator over time as functions of current and previous inputs, and the previous outputs. Additionally, a state of the controller 101 is any set of information, in general time varying, for instance an appropriate subset of current and previous inputs and outputs, that, together with the plurality of generator models 111 and future inputs, can control the plurality of generators 119 to satisfy the total demand of power.

In some embodiments, the memory 105 is further configured to store constraints 107 associated with power generation limitations of the plurality of generators 119 and a cost of power generation. The constraints 107 include equality constraints and inequality constraints on one or a combination of state and control variables of the operation of the electric grid 115.

In some embodiments, the inequality constraints include operating constraints. In an embodiment, the plurality of generators 119 is denoted by [symbol] ={1, . . . , N}, a set of time-steps in the horizon over which the plurality of generators 119 are to be controlled is denoted by [symbol] ={1, . . . , T}. Further, for each generator of the plurality of generators 119 denoted by g∈ [symbol] , the power generation at each time-step t∈ [symbol] is denoted as p_{g,t}. Accordingly, the operating constraints are defined as:

$$\begin{matrix}i . & \\ {\underline{p}}_{g , t} \leq {p}_{g , t} \leq {\overline{p}}_{g , t} & ( 1 )\end{matrix}$$

where p_{g,t}, p̅_{g,t} are a minimum power output and a maximum power output, respectively.

In some embodiments, the inequality constraints include ramp limit constraints for each generator denoted by g∈ [symbol] , t∈ [symbol] \{0}. The ramp limit constraints are defined as:

$$a . {\underline{Δ p}}_{g , t} \leq {p}_{g , t} - {P}_{g , t - 1} \leq {\overline{Δ p}}_{g , t} \qquad ( 2 )$$

where Δp_{g,t}, Δ̅p̅_{g,t} are a ramp-down limit and a ramp-up limit of the power output from the plurality of generators 119, respectively.

In some embodiments, the equality constraints may include a demand constraint. The demand constraint corresponds to a limitation of controlling the power generation operation to meet the demand denoted by dₜ at each time-step t∈ [symbol] . The demand constraint is defined as:

$${\sum }_{g ∈ 𝒢} {p}_{g , t} = {d}_{t} \qquad ( 3 )$$

In some embodiments, the processor 103 is further configured to formulate the cost of power generation from each generator of the plurality of generators 119 as a quadratic function. The quadratic function is defined as:

$$a . {\sum }_{t ∈ 𝒯} ( {c}_{g} {p}_{g , t} + {C}_{g} {p}_{g , t}^{2} ) \qquad ( 4 )$$

where c_{g}, C_{g} are cost parameters with C_{g}>0.

In some embodiments, based on the total demand of power and the current state of the operation of the electric grid 117, the processor 103 is further configured to formulate an original quadratic program (QP) for optimizing an objective function subject to the equality constraints and the inequality constraints on one or a combination of the state and the control variables of the operation of the electric grid 117. The original QP is formulated as:

$$min {\sum }_{g ∈ 𝒢} {\sum }_{t ∈ 𝒯} ( {c}_{g} {p}_{g , t} + {C}_{g} {p}_{g , t}^{2} ) \qquad ( 5 )$$

$$s . t . {\underline{p}}_{g , t} \leq {p}_{g , t} \leq {\overline{p}}_{g , {t}^{′}} {\underline{Δ p}}_{g , t} \leq {p}_{g , t} - {p}_{g , t - 1} \leq {\overline{Δ p}}_{g , t} ∀ g ∈ 𝒢 , t ∈ 𝒯 {\sum }_{g ∈ 𝒢} {p}_{g , t} = {d}_{t} ∀ t ∈ 𝒯$$

Some embodiments are based on an objective to convert the formulation in equation (5) to a formulation in equation (6) based on an introduction of slacks for converting the inequalities in equation (1) and equation (2) to equalities and transferring the lower, upper bounds on the inequalities into bounds on the slacks.

In some embodiments, the processor 103 is further configured to obtain a structural form QP based on the original QP. The structural form QP is defined as:

$$min {\sum }_{g ∈ 𝒢} {q}_{g}^{T} {x}_{g} + \frac{1}{2} {x}_{g}^{T} {Q}_{g} {x}_{g} \qquad ( 6 )$$

$$s . t . {A}_{g} {x}_{g} = {b}_{g} ∀ g ∈ 𝒢$$

$$i . {\underline{x}}_{g} \leq {x}_{g} \leq {\overline{x}}_{g} ∀ g ∈ 𝒢$$

$${\sum }_{g} {B}_{g} {x}_{g} = f$$

where x_{g} is vector variables associated with a generator g of size n_{g}. Further, the vector variables x_{g} include the power output variables denoted by p_{g,t} from the generator g for each time-steps t∈ [symbol] and the slacks that are introduced to convert the inequalities in equation (1) and equation (2). The objective function of the structural QP includes a quadratic term denoted by

$$\frac{1}{2} {x}_{g}^{T} {Q}_{g} {x}_{g}$$

and a linear term denoted by

$${q}_{g}^{T} {x}_{g} .$$

Further, q_{g}, Q_{g} are linear quadratic cost coefficients with Q_{g} is limited to a positive definite coefficient. Additionally, factor ½ associated with the quadratic term is included for reasons of consistency with literature and can also be absorbed within Q_{g} based on a computational requirement. Further, the objective function of the structural QP is subjected to linear equality constraints denoted by A_{g}x_{g}=b_{g}, where A_{g} is a matrix of size m_{g}×n_{g} and b_{g} is of size m_{g}. The objective function of the structural QP is further subjected to the inequality constraints i.e. lower and upper limits on the vector variables denoted by x_{g}, x̅_{g} respectively. The demand constraints in the equation (3) are converted into coupling constraints denoted by m_{c} that couple the variables of each generator of the plurality of generators 119 denoted by g∈ [symbol] . Further, B_{g} are matrices of size m_{c}×n_{g} and f is a vector of size m_{c}.

Some embodiments are based on an objective to control the operation of the electric grid 117 by solving the original QP. In an embodiment, a QP—based approach can be employed to minimize the cost of operation subject to the constraints 107 of the plurality of generators 117 and a satisfaction of the demand from the plurality of loads 121.

Some embodiments are based on an understanding that the original QP may be solved using various methods. In an embodiment, the optimization module 109a of the processor 103 is configured to employ various methods to solve the original QP. Examples of various methods for solving the original QP include, but are not limited to, an interior point method (IPM), an active set method (ASM), an augmented Lagrangian method (ALM), and a conjugate gradient or gradient projection method (GPM).

In some embodiments, the processor 103 is further configured to determine a control command 123b to control the electric grid 117 based on a solution of the original QP. Further, the control module 109b of the processor 103 is configured to control the operation of the electric grid 117 based on the determined control command 123b. The control command 123b includes an amount of power required to satisfy the total demand of power at each control step.

However, some embodiments are based on an understanding that the original QP is difficult to solve due to a potential non-convexity associated with the solution of the original QP and the constraints 107. To that end, some embodiments are based on an objective to overcome aforementioned problems by reformulating the original QP into a space different than an original space of the original QP. Further, the reformulated original QP is solved in the space different than the original space of the original QP. For example, some embodiments may employ the ALM to solve a Lagrangian dual of the quadratic program.

Some embodiments are based on an understanding that while the reformulation of the original QP may address aforementioned problems, another complication still exists. For example, the original QP may not have a feasible solution at all. The infeasibility can be caused by situations when the constraints 107 defining respective feasible sets do not intersect. In an example embodiment, the original QP is subjected to the equality and the inequality constraints defining two feasible sets. Further, the original QP may be infeasible due to a non-intersection of the two feasible sets. In some embodiment, the original QP that is infeasible may be referred to as “infeasible QP”.

Some embodiments are based on an objective to detect the infeasibility of the original QP by lifting, based on a lifting operation, the inequality constraints and the equality constraints into a lifted space. The lifted space comprises a dimension higher than a dimension of an original space of the original QP. Accordingly graphs are provided with reference to FIG. 1B and FIG. 1C.

FIG. 1B and FIG. 1C are graphs that collectively illustrate a lifting operation 129 for an exemplary infeasible QP, according to some embodiments of the present disclosure. The exemplary infeasible QP includes two dimensions 125, for example, a dimension 125a denoted by x₁ and a dimension 125b denoted by x₂. In other words, the exemplary infeasible original QP is two dimensional.

A set of constraints 127 includes an inequality constraint 127a denoted by x₁, x₂≥0, and an equality constraint 127b denoted by x₁+x₂=−1. Further, a non-intersection of the equality constraint 127b and the inequality constraint 127a leads to an absence of a feasible point. The feasible point corresponds to a solution of the exemplary infeasible QP.

Some embodiments are based on an objective to lift the inequality constraint 127a and the equality constraint 127b into a lifted space 131 having a dimension higher than a dimension of the exemplary infeasible QP. The lifting ensures that possible sets defined by the inequality constraint 127a and the equality constraint 127a intersect at least at one point. Further, some embodiments are based on an understanding that if an optimal solution of the original QP is found to be at that point, a determination of the solution of the infeasible QP is infeasible.

In an embodiment, the processor 103 is further configured to lift the inequality constraints 127a denoted by x₁, x₂≥0 and the equality constraints 127b denoted by x₁+x₂=−1 into a lifted space 131 having a dimension higher than a dimension of an original space of the original QP by a lifting operation 129. For instance, the lifted space 131 includes three dimensions, for example, the dimension 125a denoted by x₁ 123, the dimension 125b denoted by x₂ 125, and a dimension 133 denoted by τ. The lifting operation 129 introduces an additional non-negative variable τ such that a subspace defined by the equality constraint 127b in the lifted space 131 intersects a subspace defined by the inequality constraint 127a in the lifted space 131 at least at a point of origin 135 of the lifted space 131. In such a manner, the processor 103 is further configured to detect the infeasibility of the original QP based on a determination that the solution of the original QP in the lifted space 131 includes a value of the additional non-negative variable τ equal to zero.

In some embodiments, the processor 103 is further configured to employ one or more lifting operations to transform the constraints 107 from the original space into the lifted space 131 of the higher dimensions. Examples of the one or more lifting operations include, but are not limited to, a multiplication of the constraint 107 with one or more additional variables defining new dimensions, and affine or non-affine transformations of the constraints 107.

In some embodiments, the processor 103 is further configured to select the lifting operation 129 corresponding to a projection operation. The projection operation reverses effects of the lifting operation 129. In an example embodiment, if the lifting operation 129 includes a multiplication of values in the original space with the additional non-negative variable τ, then, the projection operation includes a division of values in the lifted space 131 by the additional non-negative variable τ. In another example embodiment, if the lifting operation 129 includes an addition of values in the original space by the additional non-negative variable τ, then, the projection operation includes a subtraction of the additional non-negative variable τ from the values in the lifted space 133.

Some embodiments are based on the recognition that in order to use the constraints 107 in the lifted space 131, there is a need to transform the original QP from the original space to the lifted space 131. However, the lifting operation 129 used for lifting the constraints 127 is not directly applicable for lifting the objective function of the original QP since the objective function includes quadratic terms and linear terms. Multiplying the quadratic terms by the additional non-negative variable τ generates an objective function that is a degree 3 polynomial and no longer a quadratic program. In other words, a direct application of the lifting operation 129 to the original QP is infeasible.

However, some embodiments are based on a realization that regardless of structure of the original QP lifted in the lifted space 131, a relationship between the optimal solution in the original space and the optimal solution in the lifted space 131 is governed by the lifting operation 129. Further, the optimal solutions, while unknown, should satisfy first-order optimality conditions. Moreover, the lifting operation 129 for the constraints 107, while not applicable to the QP objective function, is applicable to the first-order optimality conditions. Based on such a realization, the objective function of the original QP is transformed into a quadratic objective function as described below in FIG. 1D.

FIG. 1D illustrates a block diagram 100d for transformation of an objective function 139 of the original QP 137 into a homogeneous QP 143, according to some embodiments of the present disclosure. As shown by FIG. 1D, based on the lifting of the constraints 107 into the lifted space 131, the processor 103 is further configured to transform 141 the objective function 139 of the original QP 137 into a quadratic objective function 145 involving variables of the original QP 137 and the additional non-negative variable τ. The quadratic objective function 145 is subject to the lifted equality and inequality constraints 149 forms the homogeneous QP 143 in the lifted space 131 such that first-order optimality conditions 151 of the homogeneous QP 143 correspond to first-order optimality conditions 153 of the original QP 137 lifted in the higher space by the lifting operation 129.

In an embodiment, the processor 103 is further configured to reformulate the structure form QP in equation (6) into a Homogeneous Quadratic Program (HQP). The HQP is defined as:

$$min {\sum }_{g ∈ 𝒢} τ {q}_{g}^{T} {x}_{g} + \frac{1}{2} {x}_{g}^{T} {Q}_{g} {x}_{g} + \frac{{θ}_{q}}{2} {τ}^{2} - {θ}_{l} τ \qquad ( 7 )$$

$$s . t . {A}_{g} {x}_{g} = {b}_{g} τ ∀ g ∈ 𝒢$$

$${\underline{x}}_{g} τ \leq {x}_{g} \leq {\overline{x}}_{g} τ ∀ g ∈ 𝒢$$

$${\sum }_{g} {B}_{g} {x}_{g} = f τ$$

$$τ \geq 0$$

where θₗ, θ_{q}>0 are parameters. The additional variable τ is introduced and is required that it is nonnegative. The additional variable τ multiplies right-hand side terms in the equality constraints and the lower, upper bounds on the variables x_{g}. The parameter θ_{q}>0 is selected to satisfy the following condition θ_{q}+2θ*>0 where θ* is an optimal value of an equality constrained optimization problem.

In some embodiments, the processor 103 is further configured to solve the homogeneous QP 143 to produce a solution of the original QP 137 in the lifted space 131. In an embodiment, the processor 103 is further configured to project the solution in the lifted space 131 into the original space using the projection operation. The projection operation reverses the lifting operation 129 to produce the solution of the original QP 137. Further, based on the solution of the original QP 137, the processor 103 is further configured to control the electric grid 117.

The determination of the solution of the original QP 137 is described below in FIG. 1E.

Additionally or alternatively, different embodiments use different formulations of the homogeneous QP 143. Any formulation of the homogeneous QP 143 is valid as long as the first-order optimality conditions 151 of the homogeneous QP 143 correspond to the first-order optimality conditions 153 of the original QP 137 lifted in the higher space by the lifting operation 129.

However, some embodiments can impose additional rules on the formulation of the homogeneous QP 143 for different computational and optimization reasons. For example, in one embodiment, the original QP 137 is transformed such that the solution of the homogeneous QP 143 in the lifted space 131 is negative for positive values of the additional non-negative variable. This rule ensures that the optimal value in the lifted space 131 for the feasible original QP problem does not have the value of the additional variable equal to zero.

Further, some embodiments impose additional requirements on values of constants in the homogeneous QP 143. For example, in one embodiment, the homogeneous QP 143 includes a quadratic term of the additional non-negative variable scaled with a scalar. The quadratic term of the additional non-negative variable is added to the original QP 137 in order to ensure that the additional non-negative variable can take a positive value at an optimal solution of the homogeneous QP 143 when the original QP 137 is feasible.

FIG. 1E illustrates a schematic 100e of principles used by some embodiments for controlling the electric grid 117, according to some embodiments of the present disclosure. As shown by FIG. 1E, some embodiments are based on an objective to produce a solution 157 of the original QP 137 in the lifted space 131 using a Newton Method 155a. In an embodiment, the processor 103 is further configured to apply the Newton Method 155a to solve for a point satisfying first order optimality conditions 151 of the homogenous QP 143. However, a direct application of the Newton Method 155a on the homogeneous QP 143 leads to an increase in a computational complexity of computing a control step at each iteration with an increase in a number of generators of the plurality of generators 119. The increased computational complexity may lead to computationally prohibitive operations for the controller 101. In an example embodiment, the increased computational complexity corresponds to a cubic computational complexity that scales cubically with the increase in number of generators of the plurality of generators 119.

Some embodiments are based on recognizing that the additional positive variable introduced to lift the constraints and to transform the original QP into the homogeneous QP participates in coupling the structure of the homogeneous QP increasing the computational complexity. However, some embodiments are based on realizing that the decomposition can be designed to replace variables corresponding to individual generators with dual variables corresponding to the total demand of power, the additional nonnegative variable, and its corresponding dual variable. Doing in such a manner allows to perform the transformation in a computationally efficient manner allowing parallel computation. For example, some embodiments perform the computation using a central processor operatively connected to a plurality of processors of the generators to produce the control command using parallel computations of the plurality of processors enabled by the decomposition.

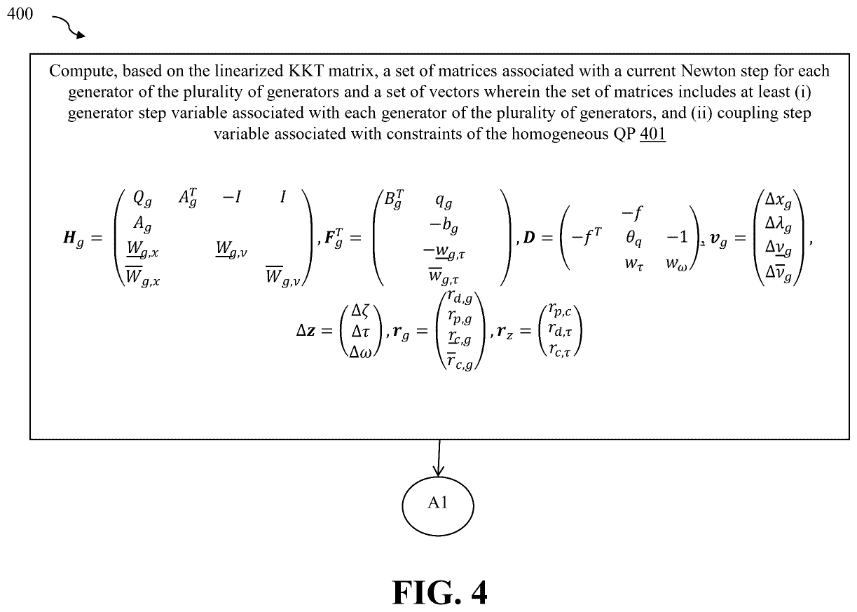

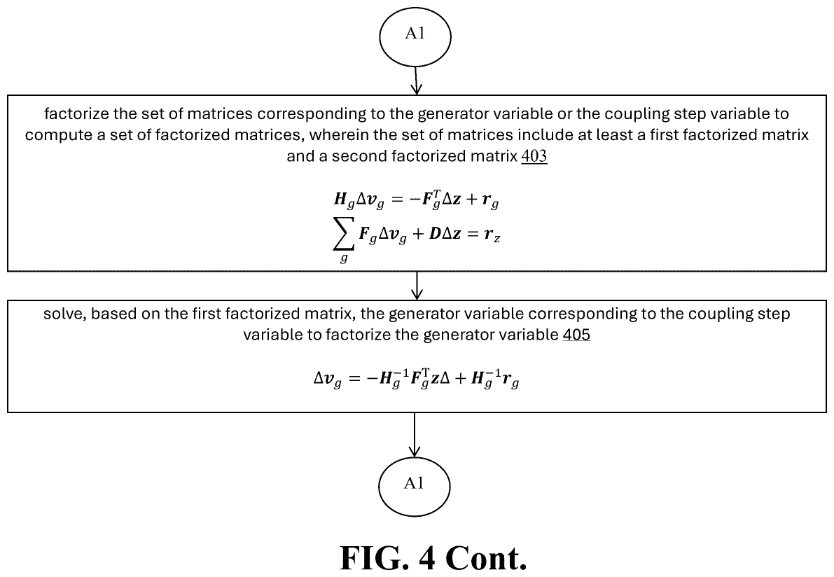

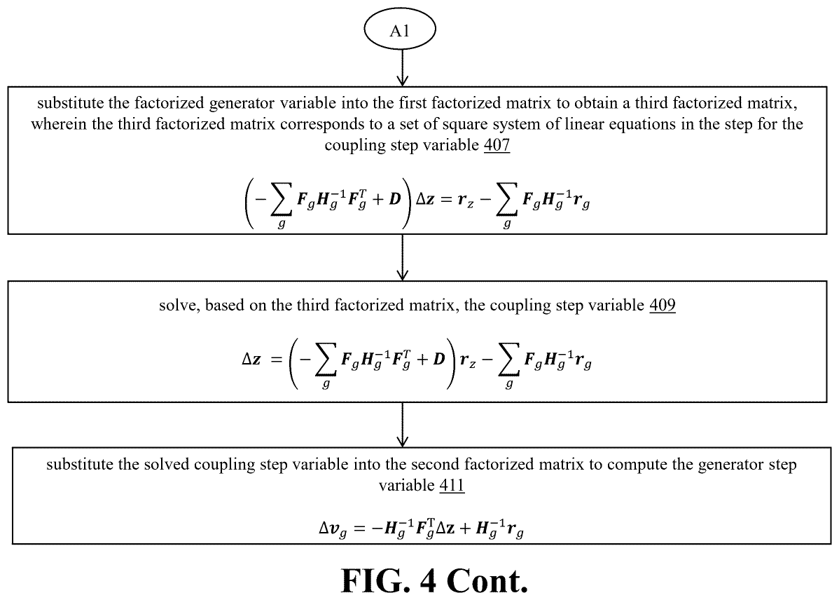

A decomposition method 155b can be applied with the Newton Method 155a to reduce 159 the computational complexity of computing the step at each iteration. In an embodiment, the processor 103 is further configured to iteratively apply the Newton Method 155a and the decomposition method 155b to produce the solution 157 of the original QP 137 in the 131. The decomposition method 155b is described in detail with reference to FIG. 4.

FIG. 1F illustrates a flowchart of a method 100f for solving the homogeneous QP 143 to produce the solution 157 of the original QP 137 in the lifted space 131 and controlling the electric grid 117 based on the solution 157 of the original QP 137 in the lifted space 131, according to an embodiment of the present disclosure. In one or more embodiments, the controller 101 may perform one or more portions of the method 100f and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the method 100f is illustrated as a sequence of steps, its contemplated that various embodiments of the method 100f may be performed in any order or combination and need not include all of the illustrated steps.

At block 161, the objective function of the structural original QP 137 is generated. In some embodiments, the processor 103 is further configured to generate the objective function of the structural QP subject to the equality constraints and the inequality constraints. In an embodiment, the processor 103 is further configured to generate the objective function of the structural QP based on the collected feedback signal 123a indicative of the current state of the operation of the electric grid 117 and the total demand of power from the plurality of generators 119 of the electric grid 117.

At block 163, parameters θₗ, θ_{q} are determined. The parameters θₗ, θ_{q} are determined by ignoring the inequality constraints in the generated objective function of the structural QP. In an embodiment, the processor 103 is further configured to determine parameters θₗ, θ_{q} by ignoring the inequality constraints in the generated objective function of the structural QP as:

$$min {\sum }_{g ∈ 𝒢} {q}_{g}^{T} {x}_{g} + \frac{1}{2} {x}_{g}^{T} {Q}_{g} {x}_{g} \qquad ( 8 )$$

$$s . t . {A}_{g} {x}_{g} = {b}_{g} ∀ g ∈ 𝒢$$

$${\sum }_{g} {B}_{g} {x}_{g} = f$$

The reformulation in equation (7) is an optimization problem that is always feasible. For instance, the solution x_{g}=0, τ=0 is feasible to all the constraints. Hence, if equation (6) is infeasible then any optimization algorithm applied to equation (7) converges to the solution where all the variables are 0.

At 165, the homogeneous QP 143 is solved. The homogenous QP 143 is solved based on the determined parameters θₗ, θ_{q} using the decomposition method 155b. In an embodiment, the processor 103 is further configured to solve, using the decomposition method 155b, the homogenous QP 143 based on the determined parameters θₗ, θ_{q}. In an embodiment, the homogeneous QP 143 includes a quadratic term of the original QP 137, a linear term of the original QP 137 scaled by the additional non-negative variable, a quadratic term of the additional non-negative variable scaled by a scalar selected to be greater than two times the negative of the lower bound of the original QP 137 and a negative linear term of the additional non-negative variable

At 167, a determination is made whether a value of the additional non-negative variable denoted by τ* in the solution in the lifted space 131 equals 0 or not. In an embodiment, the processor 103 is further configured to determine whether the value of the additional non-negative denoted by τ*.

If the value if the additional non-negative variable in the solution in the lifted space 131 is not equal to the zero then, at 169, the electric grid 117 is controlled based on an infeasibility protocol. In an embodiment, the processor 103 is further configured to control the electric grid 117 according to the infeasibility protocol when the value of the additional non-negative variable in the solution in the lifted space 131 equals zero. The infeasibility protocol can be to use an alternate method of controlling the electric grid 117 ignoring some of the inequality constraints or relaxing the inequality constraints. One type of relaxing the inequality constraints may be to remove the non-negativity bounds.

However, if the value of the additional non-negative variable in the solution in the lifted space 131 is equal to the zero, then, at 171, the solution in the lifted space 131 is projected into the original space using a projection operation denoted by

$${x}_{g}^{⋆} / {τ}^{⋆}$$

to produce the solution of the original QP 137. Specifically, if the optimization problem in equation (6) is feasible then application of any optimization algorithm to equation (7) results in an optimal solution

$${x}_{g}^{⋆} , {τ}^{⋆}$$

where τ*>0. Then, the optimal solution to equation (6) can be recovered by using the projection operation

$${x}_{g}^{⋆} / {τ}^{⋆} .$$

In an example embodiment, if the equality constraints are lifted in the lifted space 131 by scaling the equality constraints with the additional non-negative variable, then the solution in the lifted space 131 is projected to the original space by dividing the solution in the lifted space 131 with the additional non-negative variable.

In another example embodiment, the projection operation transforms a solution of the first-order conditions 151 of the homogeneous QP 143 whenever the additional non-negative variable is positive; to satisfy the first-order conditions 153 of the original QP 137.

At block 173, the control command 123b is determined. In an embodiment, the processor 103 is configured to determine the control command 123b based on the solution 157 of the original QP 137. In an embodiment, the transceiver 113 is further configured to transmit the control command 123b to the electric grid 117.

At block 175, the electric grid 117 is controlled. In an embodiment, the processor 103 is further configured to control the electric grid 117 based on the determined control command 123b. In an embodiment, the processor 103 is further configured to control, based on the control command 123b, at least one generator of the plurality of generators 119 to change a current amount of produced power to satisfy the total demand of power. In another embodiment, the processor 103 is further configured to control, based on the control command 123b, an engine speed of the at least one generator of the plurality of generators 119 to change the current amount of produced power to satisfy the total demand of power.

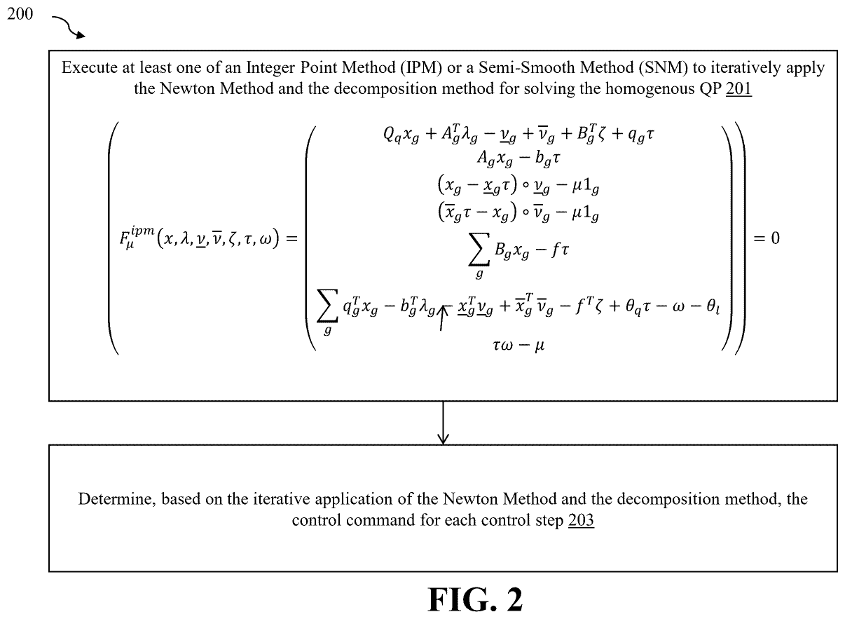

In some embodiments, to solve the homogeneous QP 143, the processor 103 is further configured to execute at least one of an Integer Point Method (IPM) or a Semi-smooth Newton Method (SMN) to iteratively apply the Newton Method 155a and the decomposition method 155b. Accordingly, a flowchart is described below in FIG. 2.

FIG. 2 illustrates a flowchart of a method 200 for solving the homogeneous QP 143 to produce the solution 157 of the original QP 137 in the lifted space 131 and controlling the electric grid 117 based on the solution 157 of the original QP 137 in the lifted space 131, according to some embodiments of the present disclosure. In one or more embodiments, the controller 101 may perform one or more portions of the method 200 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the method 200 is illustrated as a sequence of steps, its contemplated that various embodiments of the method 200 may be performed in any order or combination and need not include all of the illustrated steps.

At block 201, at least one of an Integer Point Method (IPM) or a Semi-smooth Newton Method (SSN) is executed to iteratively apply the Newton Method 155a and the decomposition method 155b.

In some embodiments, the processor 103 is further configured to execute at least one of the IPM or the SNM to apply the Newton method 155a for solving a point satisfying the stationary conditions of equation (7). In some embodiments, the stationary conditions of equation (7) may be referred to as “first-order optimality conditions 151 of the homogeneous QP 143”. Accordingly, the stationary conditions for equation (7) or the first-order optimality conditions 151 of the homogenous QP are defined as:

$${Q}_{q} {x}_{g} + {A}_{g}^{T} {λ}_{g} - {\underline{v}}_{q} + {\overline{v}}_{g} + {B}_{g}^{T} ζ + {q}_{g} τ = 0 \qquad ( 9 )$$

$${A}_{g} {x}_{g} - {b}_{g} τ = 0$$

$$( {x}_{g} - {\underline{x}}_{g} τ ) ∘ {\underline{v}}_{g} = 0$$

$$i . ( {\overline{x}}_{g} τ - {x}_{g} ) ∘ {\overline{v}}_{g} = 0$$

$${\sum }_{g} {B}_{g} {x}_{g} - f τ = 0$$

$${\sum }_{g ∈ 𝒢} ( {q}_{g}^{T} {x}_{g} - {b}_{g}^{T} {λ}_{g} + {\underline{x}}_{g}^{T} {\underline{v}}_{g} - {\overline{x}}_{g}^{T} {\overline{v}}_{g} ) - {f}^{T} ζ + {θ}_{q} τ - ω = {θ}_{l}$$

$$τω = 0$$

where, λ_{g} are multipliers for the constraints A_{g}x_{g}=b_{g}τ, v_{g}, v̅_{g} are nonnegative multipliers for the constraints x_{g}τ−x_{g}≤0, x_{g}−x̅_{g}τ≤0 respectively, ζ are multipliers for the coupling constraints Σ_{g}B_{g}x_{g}=fτ, and ω is nonnegative multiplier for the nonnegative bound on τ. The notation ∘ denotes elementwise multiplication between two vectors.

In one embodiment, the processor 103 is configured to employ the IPM to solve for a zero of equation (9). Specifically, the processor 103 is configured to execute the IPM to obtain the step by applying Newton method 155a to the following system

$${F}_{μ}^{ipm} ( x , λ , \underline{v} , \overline{v} , ζ , τ , ω ) = 0 \qquad ( 10 a )$$

where, μ>0 is a parameter that is determined as part of an IPM algorithm, x, λ, v, v̅ denotes the collection of x_{g}, λ_{g}, v_{g}, v̅_{g}, and

$$( 10 b )$$

$${F}_{μ}^{ipm} ( x , λ , \underline{v} , \overline{v} , ζ , τ , ω ) = ( \begin{matrix}{Q}_{q} {x}_{g} + {A}_{g}^{T} {λ}_{g} - {\underline{v}}_{g} + {\overline{v}}_{g} + {B}_{g}^{T} ζ + {q}_{g} τ \\ {A}_{g} {x}_{g} - {b}_{g} τ \\ ( {x}_{g} - {\underline{x}}_{g} τ ) ∘ {\underline{v}}_{g} - μ {1}_{g} \\ ( {\overline{x}}_{g} τ - {x}_{g} ) ∘ {\overline{v}}_{g} - μ {1}_{g} \\ {\sum }_{g} {B}_{g} {x}_{g} - f τ \\ {\sum }_{g} {q}_{g}^{T} {x}_{g} - {b}_{g}^{T} {λ}_{g} - {\underline{x}}_{g}^{T} {\underline{v}}_{g} + {\overline{x}}_{g}^{T} {\overline{v}}_{g} - {f}^{T} ζ + {θ}_{q} τ - ω - {θ}_{l} \\ t ω - μ\end{matrix} )$$

where 1_{g} is a vector of all ones of appropriate dimension. The IPM algorithm satisfies inequalities in equation (7) by choosing an initial iterate that satisfies them strictly and enforcing this at every iteration of the IPM algorithm. Similarly, the non-negativity on multipliers v, v̅, ω is enforced at every iteration of the IPM algorithm.

At block 203, based on the iterative application of the Newton Method 155a and the decomposition method 155b, the control command 123b is determined. In an embodiment, based on the iterative application of the Newton Method 155a and the decomposition method 155b, the processor 103 is further configured to determine the solution of the homogenous QP 143 in the lifted space. Further, based on the solution of the homogenous QP 143, the processor 103 is further configured to determine the control command 123b for each control step.

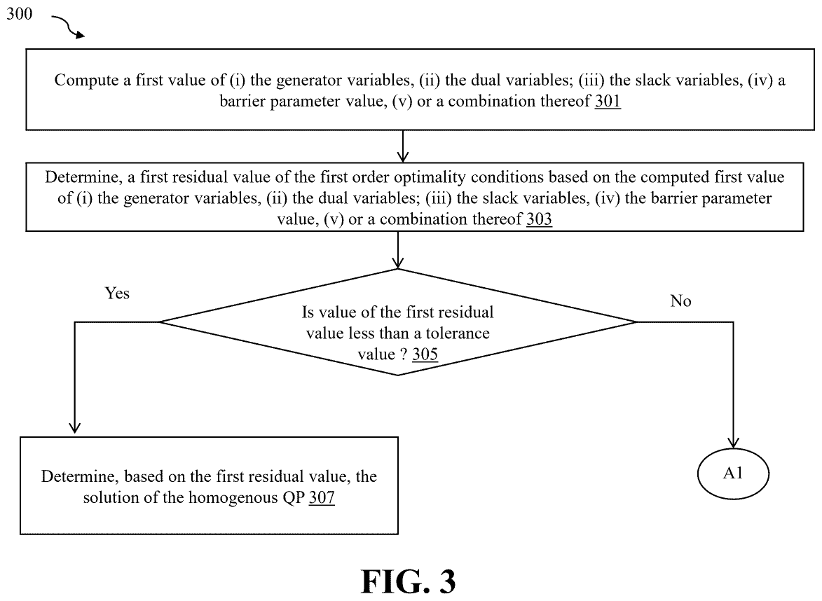

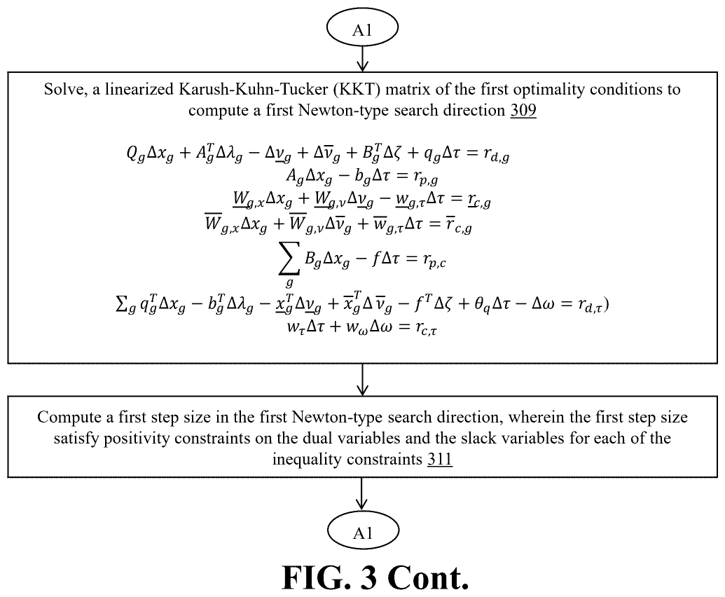

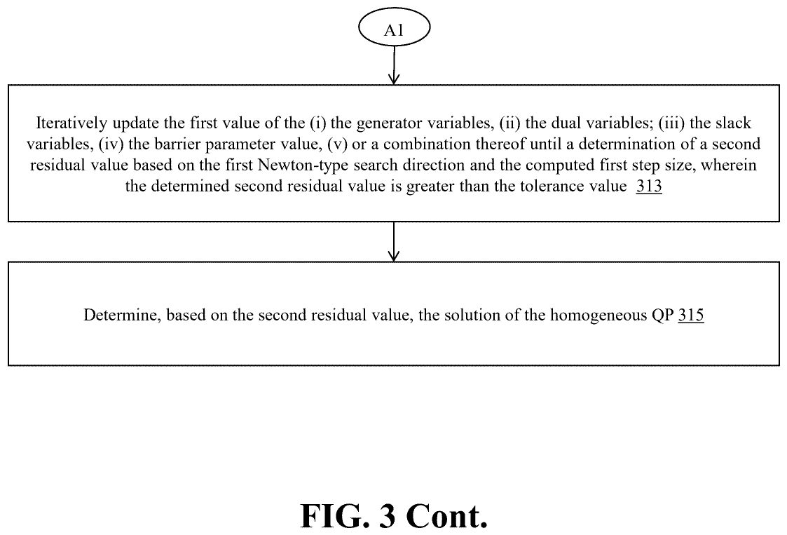

In some embodiments, in the iterative application of the Newton Method 155a and the decomposition method 155b to determine the control command 123b for each control step, the processor 103 is further to solve the homogenous QP 143 by iteratively solving the first-order optimality conditions 151 of the homogeneous QP 143. Additionally, each iteration of the IPM algorithm output generator variables associated with the power generation level of each generator of the plurality of generators 119 and dual variables with respect to the equality constraints and dual variables and slack variables with respect to the inequality constraints. Accordingly, a flowchart is described in detail with reference to FIG. 3.

FIG. 3 illustrates a flowchart of a method 300 for executing the IPM method in a current iteration, according to some embodiments of the present disclosure. In one or more embodiments, the controller 101 may perform one or more portions of the method 300 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the method 300 is illustrated as a sequence of steps, its contemplated that various embodiments of the method 300 may be performed in any order or combination and need not include all of the illustrated steps.

At block 301 a first value of one or a combination of the generator variables, the dual variables, the slack variables, and a barrier parameter value is calculated.

At block 303, a first residual value of the first order optimality conditions 151 is determined based on the computed first value of one or a combination of the generator variables, the dual variables, the slack variables, and the barrier parameter value.

At block 305, a determination is made whether the determined first residual value is less than a tolerance value or not. If the determined first residual value is less than the tolerance value, then, at 307, the solution of the homogeneous QP 143 is determined based on the first residual value.

However, if the first residual value is not less than the tolerance value, then, at 309, a linearized karush Tucker (KKT) matrix of the first optimality conditions 151 to compute a first Newton-type search direction. In an embodiment, the processor 103 is further configured to determine the linearized KKT matrix from a linear system associated with the computation of the step. The linear system is defined as:

$${Q}_{g} Δ {x}_{g} + {A}_{g}^{T} Δ {λ}_{g} - Δ {\underline{v}}_{g} + Δ {\overline{v}}_{g} + {B}_{g}^{T} Δ ζ + {q}_{g} Δ τ = {r}_{d , g} \qquad ( 11 a )$$

$${A}_{g} Δ {x}_{g} - {b}_{g} Δ τ = {r}_{p , g} \qquad ( 11 b )$$

$${\underline{W}}_{g , x} Δ {x}_{g} + {\underline{W}}_{g , v} Δ {\underline{v}}_{g} - {\underline{w}}_{g , τ} Δ τ = - {r}_{c , g} \qquad ( 11 c )$$

$${\overline{W}}_{g , x} Δ {x}_{g} + {\overline{W}}_{g , v} Δ {\overline{v}}_{g} + {\overline{w}}_{g , τ} Δ τ = {\overline{r}}_{c , g} \qquad ( 11 d )$$

$${\sum }_{g} {B}_{g} Δ {x}_{g} - f Δ τ = {r}_{p , c} \qquad ( 11 e )$$

$${\sum }_{g} {q}_{g}^{T} Δ {x}_{g} - {b}_{g}^{T} Δ {λ}_{g} - {x}^{T} Δ {\underline{v}}_{g} + {\overline{x}}_{g}^{T} Δ {\overline{v}}_{g} - {f}^{T} Δ ζ + {θ}_{q} Δτ - Δ ω = {r}_{d , τ} \qquad ( 11 f )$$

$${w}_{τ} Δ τ + {w}_{ω} Δ ω = {r}_{c , τ} \qquad ( 11 g )$$

where r_{d,g}, r_{p,g}, r_{c,g}, r̅_{c,g}, r_{p,c}, r_{d,τ}, r_{c,τ} are the negative of the quantities on the left hand side of equation (10) evaluated at the iterate from which the step is computed. In the above, W_{g,x}, W_{g,v} are diagonal matrices with v_{g}, x_{g}−x_{g}τ respectively on the diagonal, W̅_{g,x}, W̅_{g,v} are diagonal matrices with v̅_{g}, x̅_{g}τ−x_{g} respectively on the diagonal, w_{g,τ}, w̅_{g,τ} are respectively x_{g}, x̅_{g}.

At block 311, a first step size in the first Newton-type search direction is computed. The first step size satisfies positivity constraints on the dual variables and the slack variables for each of the inequality constraints.

At block 313, the first value of the one or a combination of the generator variables, the dual variables, the slack variables, and the barrier parameter value is iteratively updated until a determination of a second residual value, based on the first Newton-type search direction and the computed first step size. Further, the determined second residual value is greater than the tolerance value.

At block 315, based on the second residual value, the solution of the homogeneous QP 143 is determined.

In some embodiments, the processor 103 is further configured to execute the IPM algorithm to apply decomposition Method 155b with the Newton Method 155a. Accordingly a schematic is provided with reference to FIG. 4.

FIG. 4 illustrates a flowchart of a method 400 for applying the decomposition method 155b, according to some embodiments of the present disclosure. In one or more embodiments, the controller 101 may perform one or more portions of the method 400 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the method 400 is illustrated as a sequence of steps, its contemplated that various embodiments of the method 400 may be performed in any order or combination and need not include all of the illustrated steps.

At block 401, based on the linearized KKT matrix, a set of matrices and a set of vectors are computed. The set of matrices and the set of vectors are associated with a current Newton step for each generator of the plurality of generators 119. Further, the set of matrices includes at least generator step variable denoted by Δv_{g} associated with each generator of the plurality of generators 119, and coupling step variable denoted by Δz associated with constraints of the homogeneous QP 143.

In an embodiment, the linear system in equation (6) is defined as:

$$( \begin{matrix}{H}_{1} & & & {F}_{1}^{T} \\ & ⋱ & & ⋮ \\ & & {H}_{\vert 𝒢 \vert} & {F}_{\vert 𝒢 \vert}^{T} \\ {F}_{\vert 𝒢 \vert} & … & {F}_{\vert 𝒢 \vert} & D\end{matrix} ) ( \begin{matrix}Δ {v}_{1} \\ ⋮ \\ Δ {v}_{\vert 𝒢 \vert} \\ Δ z\end{matrix} ) = ( \begin{matrix}{r}_{1} \\ ⋮ \\ {r}_{\vert 𝒢 \vert} \\ {r}_{z}\end{matrix} ) \qquad ( 12 )$$

Where, the generator step variable denoted by Δv_{g} indicative of (i) a step denoted by Δx_{g} in the power generation level variables of each generator of the plurality of generators 119, (ii) a step denoted by Δλ_{g} in the dual variables for the equality constraints model an operation of the plurality of generators 119; (iii) a step denoted by Δv_{g} in the dual variables for the lower constraints in the operation of the plurality of generators, and (iv) a step denoted by Δv̅_{g} in the dual variables for the upper constraints in the operation of the plurality of generators 119.

Additionally, the coupling variable denoted by Δz indicative of (i) a step denoted by Δζ in constraint variables that correspond to coupling constraints, (ii) a step denoted by Δτ in the dual variables for the demand satisfaction constraints, and (iii) a step denoted by Δω in homogenizing variables and corresponding dual variables associated with the homogenous QP 143. The homogenizing variables are introduced in the Homogenous QP 143 to determine the infeasibility of the original QP.

Some embodiments are based on an understanding that a direct application of the Newton Method 155a in equation (12) leads to a cubic complexity in the number of generators. Hence, some embodiments are based on a realization that the decomposition method 155b can be employed with the Newton Method 155a to reduce 159 the computational complexity of the computation of the step in the equation (12).

In the decomposition method 155b, the processor 103 is further configured to compute the set of matrices as:

$${H}_{g} = ( \begin{matrix}{Q}_{g} & {A}_{g}^{T} & - I & I \\ {A}_{g} & & & \\ {\underline{W}}_{g , x} & & {\underline{W}}_{g , v} & \\ {\overline{W}}_{g , x} & & & {\overline{W}}_{g , v}\end{matrix} ) , {F}_{g}^{T} = ( \begin{matrix}{B}_{g}^{T} & {q}_{g} \\ & - {b}_{g} \\ & - {\underline{w}}_{g , τ} \\ & {\overline{w}}_{g , τ}\end{matrix} ) , D = ( \begin{matrix} & - f & \\ - {f}^{T} & {θ}_{q} & - 1 \\ & {w}_{τ} & {w}_{ω}\end{matrix} )$$

Additionally, the processor 103 is further configured to compute the set of vectors as:

$${v}_{g} = ( \begin{matrix}Δ {x}_{g} \\ Δ {λ}_{g} \\ Δ {\underline{v}}_{g} \\ Δ {\overline{v}}_{g}\end{matrix} ) , Δ z = ( \begin{matrix}Δ ζ \\ Δ τ \\ Δ ω\end{matrix} ) , {r}_{g} = ( \begin{matrix}{r}_{d , g} \\ {r}_{p , g} \\ {\underline{r}}_{c , g} \\ {\overline{r}}_{c , g}\end{matrix} ) , {r}_{z} = ( \begin{matrix}{r}_{p , c} \\ {r}_{d , τ} \\ {r}_{c , τ}\end{matrix} )$$

At block 403, the set of matrices are factorized corresponding to the generator variable or the coupling step variable to compute a set of factorized matrices. The set of matrices include at least a first factorized matrix and a second factorized matrix.

In an embodiment, the first factorized matrix is defined as:

$${H}_{g} Δ {v}_{g} = - {F}_{g}^{T} Δ z + {r}_{g} \qquad ( 13 )$$

In another embodiment, the second factorized matrix is defined as:

$${\sum }_{g} {F}_{g} Δ {v}_{g} + D Δ z = {r}_{z} \qquad ( 14 )$$

At block 405, based on the first factorized matrix, the generator variable corresponding to the coupling step variable is solved to factorize the generator variable. The factorized generator variable is defined as:

$$Δ {v}_{g} = - {H}_{g}^{- 1} {F}_{g}^{T} Δ z + {H}_{g}^{- 1} {r}_{g} \qquad ( 15 )$$

At block 407, the factorized generator variable is substituted into the first factorized matrix to obtain a third factorized matrix. The third factorized matrix corresponds to a set of square system of linear equations in the step for the coupling step variable denoted by Δz. The third factorized matrix is defined as:

$$( - {\sum }_{g} {F}_{g} {H}_{g}^{- 1} {F}_{g}^{T} + D ) Δ z = {r}_{z} - {\sum }_{g} {F}_{g} {H}_{g}^{- 1} {r}_{g} \qquad ( 16 )$$

In an embodiment, based on the first factorized matrix, the processor 103 is further configured to substitute the step in the power generation level variables of each generator of the plurality of generators 119, the step in the dual variables for the equality constraints model the operation of the plurality of generators 119 with respect to the step in constraint variables that correspond to the coupling constraints, the step in the dual variables for the demand satisfaction constraints, and the step in the homogenizing variables and the corresponding dual variables associated with the homogenous QP 143.

At block 409, based on the third factorized matrix, the coupling step variable is solved as:

$$Δ z = ( - {\sum }_{g} {F}_{g} {H}_{g}^{- 1} {F}_{g}^{T} + D ) {r}_{z} - {\sum }_{g} {F}_{g} {H}_{g}^{- 1} {r}_{g} \qquad ( 17 )$$

At block 411, the solved coupling step variable is substituted into the second factorized matrix to compute the generator step variable denoted by Avg. The computed generator step variable is defined as:

$$Δ {v}_{g} = - {H}_{g}^{- 1} {F}_{g}^{T} Δ z + {H}_{g}^{- 1} {r}_{g} \qquad ( 18 )$$

In an embodiment, to compute the generator step variable, the processor 103 is further configured to substitute the step in constraint variables that correspond to coupling constraints, the step in the dual variables for the demand satisfaction constraints, and a step in homogenizing variables and corresponding dual variables associated with the homogenous QP 143 with respect to the step in the power generation level variables of each generator of the plurality of generators, the step in the dual variables for the equality constraints model the operation of the plurality of generators 119, the step in the dual variables for the lower constraints in the operation of the plurality of generators 119, and the step in the dual variables for the upper constraints in the operation of the plurality of generators 119.

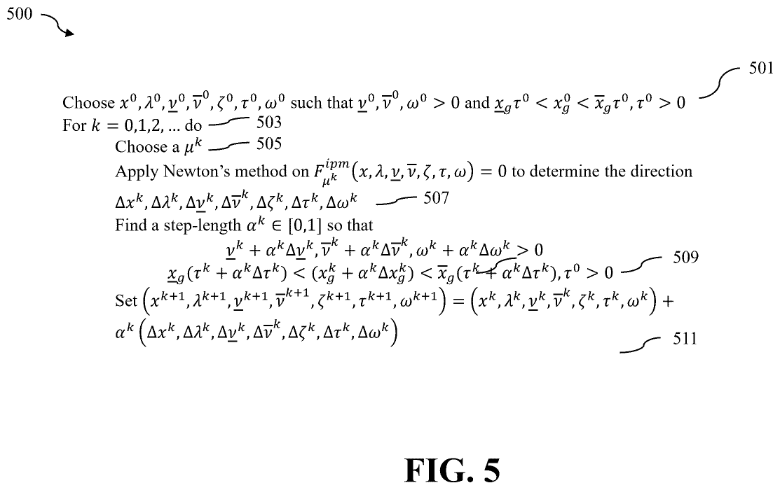

FIG. 5 illustrates an IPM algorithm 500 for determining the solution of the homogeneous QP 143, according to some embodiments of the present disclosure. In one or more embodiments, the controller 101 may perform one or more portions of the IPM algorithm 500 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the IPM algorithm 500 is illustrated as a sequence of steps, its contemplated that various embodiments of the IPM algorithm 500 may be performed in any order or combination and need not include all of the illustrated steps.

At step 501, (x⁰, λ⁰, v⁰, v̅⁰, ζ⁰, τ⁰, ω⁰) is chosen such that (v⁰, v̅⁰, ω⁰)>0, and x_{g}τ⁰<x_{g}⁰<x̅_{g}τ⁰, τ⁰>0.

At step 503, an iterative procedure is executed for an iteration k. In an embodiment, the iterative procedure is conducted until is a residual value is greater than the tolerance value denoted as ∈>0.

At step 505, the barrier parameter denoted by μ^{k} is chosen.

At step 505 a search direction d^{k}=(Δx^{k}, Δλ^{k}, Δv^{k}, Δv̅^{k}, Δζ^{k}, Δτ^{k}, Δω^{k}) is computed based on an application of the Newton Method 155a.

At step 507, a step-length α^{k}∈(0,1] is computed to move along the direction d^{k} such that

$${\underline{v}}^{k} + {α}^{k} Δ {\underline{v}}^{k} , {\overline{v}}^{k} + {α}^{k} Δ {\overline{v}}^{k} , {ω}^{k} + {α}^{k} Δ {ω}^{k} > 0 , and {\underline{x}}_{g} ( {τ}^{k} + {α}^{k} Δ {τ}^{k} ) < ( {x}_{g}^{k} + {α}^{k} Δ {x}_{g}^{k} ) < {\overline{x}}_{g} ( {τ}^{k} + {α}^{k} Δ {τ}^{k} .$$

At step 509, (x^{k+1}, τ^{k+1}, ξ^{k+1}, ζ^{k+1}, ω^{k+1}) is set as (x^{k+1}, τ^{k+1}, ξ^{k+1}, ζ^{k+1}, ω^{k+1})=(x^{k}, τ^{k}, ζ^{k}, ω^{k})+α^{k}(dx^{k}, dτ^{k}, dζ^{k}, dω^{k}).

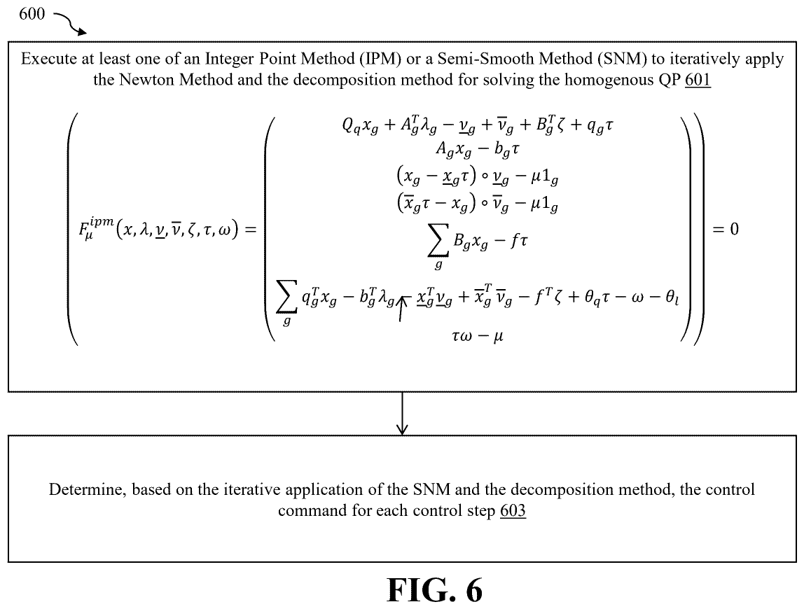

In some embodiments, the processor 103 is further configured to execute a Semi-Smooth Newton Method to solve the homogeneous QP 143. Accordingly a flowchart is described in detail with reference to FIG. 6.

FIG. 6 illustrates a flowchart of a method 600 for solving the homogeneous QP 143 to produce the solution 157 of the original QP 137 in the lifted space 131 and controlling the electric grid 117 based on the solution 157 of the original QP 137 in the lifted space 131, according to some embodiments of the present disclosure. In one or more embodiments, the controller 101 may perform one or more portions of the method 600 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the method 600 is illustrated as a sequence of steps, its contemplated that various embodiments of the method 600 may be performed in any order or combination and need not include all of the illustrated steps.

At block 601, the SNM is executed to iteratively apply the Newton Method 155a and the decomposition method 155b.

In some embodiments, the processor 103 is further configured to execute the SNM to apply the Newton method 155a for solving the homogenous QP 143. Specifically, the SNM is employed to solve the for a zero of equation (9). In an embodiment, the SNM obtains a step by applying the Newton method 155a to a system defined as:

$${F}^{s n m} ( x , λ , \underline{v} , \overline{v} , ζ , τ , ω ) = 0 \qquad ( 19 )$$

where x, λ, v, v̅ denotes the collection of x_{g}, λ_{g}, v_{g}, v̅_{g}, and

$$( 19 )$$

$${F}^{snm} ( x , λ , \underline{v} , \overline{v} , ζ , τ , ω ) = ( \begin{matrix}{Q}_{q} {x}_{g} + {A}_{g}^{T} {λ}_{g} - {\underline{v}}_{g} + {\overline{v}}_{g} + {B}_{g}^{T} ζ + {q}_{g} τ \\ {A}_{g} {x}_{g} - {b}_{g} τ \\ Φ ( {x}_{g} - {\underline{x}}_{g} τ , {\underline{v}}_{g} ) \\ Φ ( {\overline{x}}_{g} τ - {x}_{g} , {\overline{v}}_{g} ) \\ {\sum }_{g} {B}_{g} {x}_{g} - f τ \\ {\sum }_{g} {q}_{g}^{T} {x}_{g} - {b}_{g}^{T} {λ}_{g} - {\underline{x}}_{g}^{T} {\underline{v}}_{g} + {\overline{x}}_{g}^{T} {\overline{v}}_{g} - {f}^{T} ζ + {θ}_{q} τ - ω - {θ}_{l} \\ ϕ ( τ , ω )\end{matrix} )$$

where ϕ(a, b)=−a−b+\sqrt{a²+b²} for scalars a, b and Φ(a, b)=(ϕ(a₁, b₁), . . . , ϕ(aₙ, bₙ)) for vectors a, b.

At block 603, based on the iterative application of the Newton Method 155a and the decomposition method 155b, the control command 123b is determined. In an embodiment, based on the iterative application of the Newton Method 155a and the decomposition method 155b, the processor 103 is further configured to determine the solution of the homogenous QP 143 in the lifted space. Further, based on the solution of the homogenous QP 143, the processor 103 is further configured to determine the control command 123b for each control step.

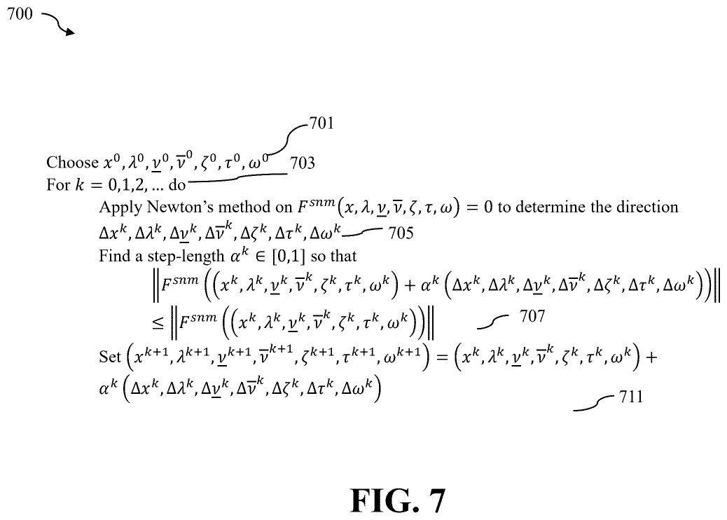

FIG. 7 illustrates an SNM algorithm 600 for determining the solution of the homogeneous QP 143, according to some embodiments of the present disclosure. In one or more embodiments, the controller 101 may perform one or more portions of the SNM algorithm 600 and may be implemented in, for instance the processor 103. As such, the controller 101 may provide means for accomplishing embodiments of other process described herein in conjunction with other components of the controller 101. In an example embodiment, the processor 103 is further configured to cause the controller 101 for accomplishing embodiments of other process described herein in conjunction with other components of the controller 101. Although the SNM algorithm 600 is illustrated as a sequence of steps, its contemplated that various embodiments of the SNM algorithm 600 may be performed in any order or combination and need not include all of the illustrated steps.

At step 701, (x⁰, λ⁰, v⁰, v̅⁰, ζ⁰, τ⁰, ω⁰) is chosen.

At step 703, an iterative procedure is executed for an iteration k. In an embodiment, the iterative procedure is conducted until is a residual value is greater than the tolerance value denoted as ∈>0.

At step 705 a search direction d^{k}=(Δx^{k}, Δλ^{k}, Δv^{k}, Δv̅^{k}, Δζ^{k}, Δτ^{k}, Δω^{k}) is computed based on an application of the Newton Method 155a.

At step 707, a step-length α^{k}∈(0,1] is computed to move along the direction d^{k} such that:

$$i . \text{} ‖ {F}^{s n m} ( \text{} ( {x}^{k} , {λ}^{k} , {\underline{v}}^{k} , {\overline{v}}^{k} , {ζ}^{k} , {τ}^{k} , {ω}^{k} ) + {α}^{k} ( Δ {x}^{k} , {Δλ}^{k} , Δ {\underline{v}}^{k} , Δ {\overline{v}}^{k} , Δ {ζ}^{k} , {Δτ}^{k} , {Δω}^{k} ) ) ‖ \leq \text{} ‖ {F}^{s n m} ( ( {x}^{k} , {λ}^{k} , {\underline{v}}^{k} , {\overline{v}}^{k} , {ζ}^{k} , {τ}^{k} , {ω}^{k} ) ) ‖$$

At step 709, x^{k+1}, λ^{k+1}, v^{k+1}, v̅^{k+1}, ζ^{k+1}, τ^{k+1}, ω^{k+1}) is set as x^{k}, λ^{k}, v^{k}, v̅^{k}, ζ^{k}, τ^{k}, ω^{k})+α^{k}(Δx^{k}, Δλ^{k}, Δv^{k}, Δv̅^{k}, Δζ^{k}, Δτ^{k}, Δω^{k}).

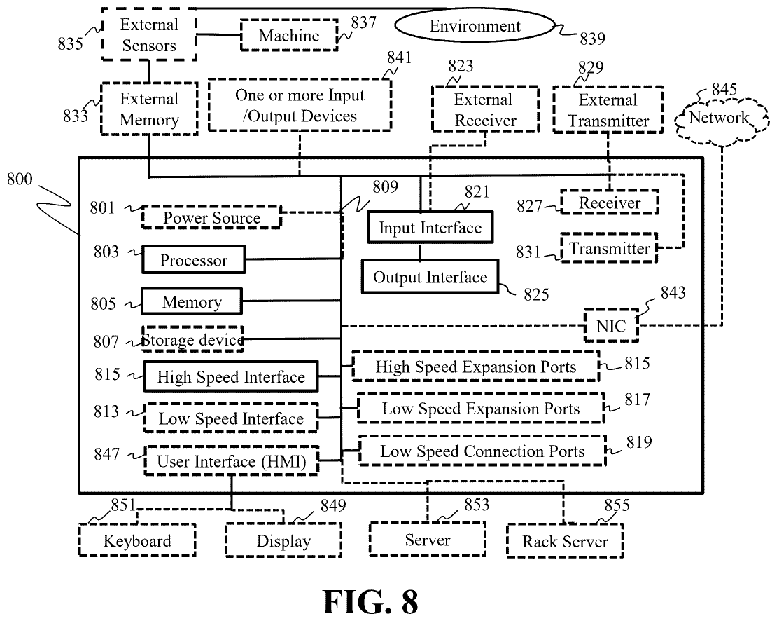

FIG. 8 is a schematic illustrating a computing device 800 for implementing of systems and methods of the present disclosure. The computing device 800 includes a power source 801, a processor 803, a memory 805, a storage device 807, all connected to a bus 809. Further, a high-speed interface 811, a low-speed interface 813, high-speed expansion ports 815 and low speed connection ports 817, can be connected to the bus 809. In addition, a low-speed expansion port 819 is in connection with the bus 809. Further, an input interface 821 can be connected via the bus 809 to an external receiver 823 and an output interface 825. A receiver 827 can be connected to an external transmitter 829 and a transmitter 831 via the bus 809. Also connected to the bus 809 can be an external memory 833, external sensors 835, machine(s) 837, and an environment 839. Further, one or more external input/output devices 841 can be connected to the bus 809. A network interface controller (NIC) 843 can be adapted to connect through the bus 809 to a network 845, wherein data or other data, among other things, can be rendered on a third-party display device, third party imaging device, and/or third-party printing device outside of the computing device 800.

The memory 805 can store instructions that are executable by the computing device 800 and any data that can be utilized by the methods and systems of the present disclosure. The memory 805 can include random access memory (RAM), read only memory (ROM), flash memory, or any other suitable memory systems. The memory 805 can be a volatile memory unit or units, and/or a non-volatile memory unit or units. The memory 805 may also be another form of computer-readable medium, such as a magnetic or optical disk.

The storage device 807 can be adapted to store supplementary data and/or software modules used by the computer device 800. The storage device 807 can include a hard drive, an optical drive, a thumb-drive, an array of drives, or any combinations thereof. Further, the storage device 807 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 803), perform one or more methods, such as those described above.

The computing device 800 can be linked through the bus 809, optionally, to a display interface or user Interface (HMI) 847 adapted to connect the computing device 800 to a display device 849 and a keyboard 851, wherein the display device 849 can include a computer monitor, camera, television, projector, or mobile device, among others. In some implementations, the computer device 800 may include a printer interface to connect to a printing device, wherein the printing device can include a liquid inkjet printer, solid ink printer, large-scale commercial printer, thermal printer, UV printer, or dye-sublimation printer, among others.

The high-speed interface 811 manages bandwidth-intensive operations for the computing device 800, while the low-speed interface 813 manages lower bandwidth-intensive operations. Such allocation of functions is an example only. In some implementations, the high-speed interface 811 can be coupled to the memory 805, the user interface (HMI) 849, and to the keyboard 851 and the display 849 (e.g., through a graphics processor or accelerator), and to the high-speed expansion ports 815, which may accept various expansion cards via the bus 809. In an implementation, the low-speed interface 813 is coupled to the storage device 807 and the low-speed expansion ports 817, via the bus 809. The low-speed expansion ports 817, which may include various communication ports (e.g., USB, Bluetooth, Ethernet, wireless Ethernet) may be coupled to the one or more input/output devices 841. The computing device 800 may be connected to a server 853 and a rack server 855. The computing device 800 may be implemented in several different forms. For example, the computing device 800 may be implemented as part of the rack server 855.

### Exemplar Embodiments

Let [symbol] ={1, . . . , N} be the set of generators and [symbol] ={1, . . . , T} denote the set of time-steps in the horizon over which the generators are to be controlled. For each generator g∈ [symbol] the power generation at each time-step t∈ [symbol] is denoted as p_{g,t} operating constraints can be succinctly represented as

$$i . {\underline{p}}_{g , t} \leq {p}_{g , t} \leq {\overline{p}}_{g , t} \qquad ( 20 )$$

where p_{g,t}, p̅_{g,t} are respectively the minimum and maximum power output. In addition, there may be additional constraints for each generator g∈ [symbol] , t∈ [symbol] \{0} such as ramp limits

$$a . {\underline{Δ p}}_{{g , t}_{}} \leq {p}_{g , t} - {p}_{g , t - 1} \leq {\overline{Δ p}}_{g , t} \qquad ( 21 )$$

where Δp_{g,t}, Δ̅p̅_{g,t} are respectively the limits for ramp-down and ramp-up of the power output from the generators. The goal of controlling power generation is to meet the demand dₜ at each time-step t∈ [symbol] which is expressed as

$$i . {\sum }_{g ∈ 𝒢} {p}_{g , t} = {d}_{t} \qquad ( 22 )$$

The cost of power generation from each generator is typically posed as a quadratic function

$$a . {\sum }_{t ∈ 𝒯} ( {c}_{g} {p}_{g , t} + {C}_{g} {p}_{g , t}^{2} ) \qquad ( 23 )$$

where c_{g}, C_{g} are cost parameters with C_{g}>0.

The problem that the electric grid operator solves can be posed as the Quadratic Program (QP)

$$min {\sum }_{g ∈ 𝒢} {\sum }_{t ∈ 𝒯} ( {c}_{g} {p}_{g , t} + {C}_{g} {p}_{g , t}^{2} ) \qquad ( 24 )$$

$$a . s . t . ∀ g ∈ 𝒢 , t ∈ 𝒯 \qquad Eq ( 1 ) - ( 2 )$$

$$∀ t ∈ 𝒯 \qquad Eq ( 3 )$$

The problem in Eq (24) can be identified to be of the following structural form QP

$$min {\sum }_{g ∈ 𝒢} {q}_{g}^{T} {x}_{g} + \frac{1}{2} {x}_{g}^{T} {Q}_{g} {x}_{g} \qquad ( 25 )$$

$$s . t . {A}_{g} {x}_{g} = {b}_{g} ∀ g ∈ 𝒢$$

$$i . {\underline{x}}_{g} \leq {x}_{g} \leq {\overline{x}}_{g} ∀ g ∈ 𝒢$$

$${\sum }_{g} {B}_{g} {x}_{g} = f$$

Where x_{g} is vector variables associated with a generator g of size n_{g}, q_{g}, Q_{g} are linear, quadratic cost coefficients with Q_{g} being strictly positive definite. The matrix A_{g} is a matrix of size m_{g}×n_{g} and the right-hand side b_{g} is of size m_{g}. The lower and upper limits on the variables are x_{g}, x_{g} respectively. The matrices B_{g} are of size m_{c}×n_{g} and f is a vector of size m_{c}. The formulation in Eq (24) can be converted into the form in Eq (25) after the introduction of slacks for converting the inequalities in Eq (20) and Eq (21) to equalities and transferring the lower, and upper bounds on the inequalities into bounds on the slacks. The variables x_{g} consist of the power output variables p_{g,t} from generator g for all time-steps t∈ [symbol] and the slacks that are introduced to convert the inequalities in Eq (20) and (21). The constraints Eq (22) are converted into m_{c} constraints that couple the variables from all the generators g∈ [symbol] .

Some embodiments provide a system and a method for controlling an operation of generators using a controller. An example of the controller is a Quadratic Program (QP)-based approach that minimizes a cost of operation subject to the constraints of the generators and satisfaction of demand from the consumers.

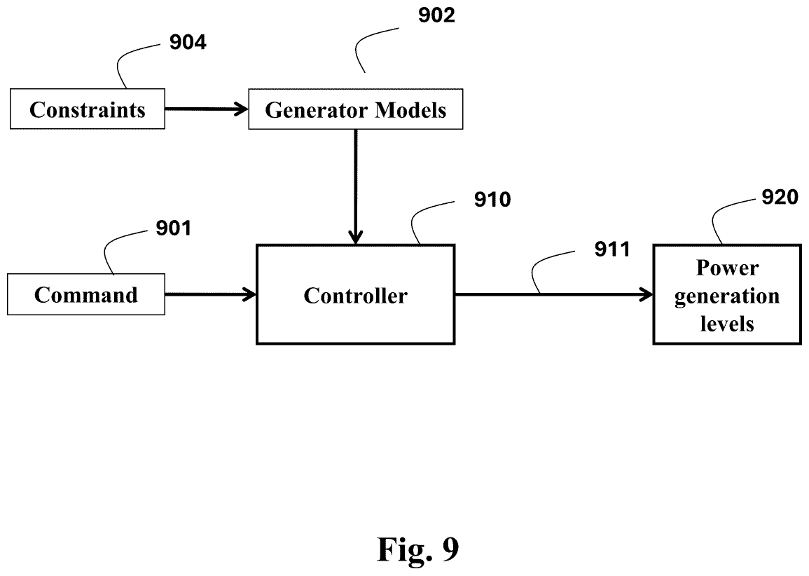

FIG. 9 shows an example controller 910 to control the generation levels 920 according to some embodiments. In some implementations, the controller is an optimization based controller programmed according to generator models 902. The model can be a set of equations representing the limits of generators which are represented through constraints 904 and the cost of generation. During the operation, the controller receives a command 901 indicating the power demand that needs to be satisfied over a time horizon. In response to receiving the command 901, the controller generates a control signal 911 that serves as an input for the generators.

The command herein refers to the set of power demands dₜ that must be satisfied by the generators g∈ [symbol] . These constitute the vectors f in Eq (25). The control signal that is obtained on solving the QP is the power generation levels of the generators p_{g,t} in Eq (24) which constitute vector x_{g} in Eq (25). The control signal states the amount of power to be produced by each generator at each time.

A model of system 902 can include a set of mathematical equations that describe how the system outputs change over time as functions of current and previous inputs, and the previous outputs. The state of the system is any set of information, in general time-varying, for instance, an appropriate subset of current and previous inputs and outputs, that, together with the model of the system and future inputs, can uniquely define the future motion of the system.

The system can be subject to physical limitations and specification constraints 904 limiting the range where the outputs, the inputs, and also possibly the states of the system are allowed to operate.

The controller 910 can be implemented in hardware or as a software program executed in a processor, e.g., a microprocessor, which at fixed or variable control period sampling intervals receives the estimated state of the system 921 and the desired motion command 901 and determines, using this information, the inputs, e.g., the control signal 911, for operating the system.

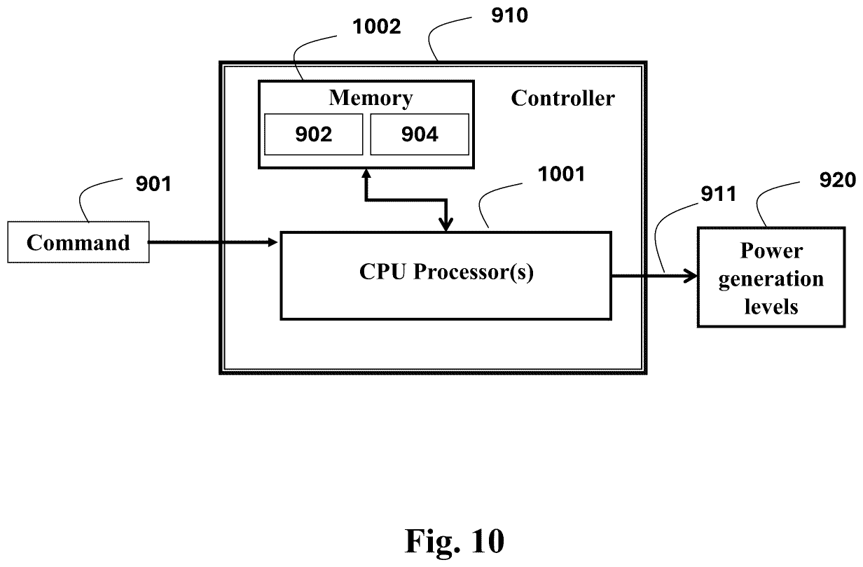

FIG. 10 shows a block diagram of a controller 910 according to some embodiments, which actuates the system to follow a command 901. The controller 910 includes a computer, e.g., in the form of a single central processing unit (CPU) or multiple CPU processors 1001 connected to memory 1002 for storing the model 902 and the constraints 904 on the operation of the system.

Consider the reformulation of the optimization problem in Eq (25) as follows into a Homogeneous Quadratic Program (HQP)

$$min {\sum }_{g ∈ 𝒢} τ {q}_{g}^{T} {x}_{g} + \frac{1}{2} {x}_{g}^{T} {Q}_{g} {x}_{g} + \frac{{θ}_{q}}{2} {τ}^{2} - {θ}_{l} τ \qquad ( 26 )$$

$$s . t . {A}_{g} {x}_{g} = {b}_{g} τ ∀ g ∈ 𝒢$$

$$a . {\underline{x}}_{g} τ \leq {x}_{g} \leq {\overline{x}}_{g} τ ∀ g ∈ 𝒢$$

$${\sum }_{g} {B}_{g} {x}_{g} = f τ$$

$$τ \geq 0$$

where θₗ, θ_{q}>0 are parameters. An additional variable τ is introduced and is required that it is nonnegative. The additional variable τ multiplies right-hand side terms in the equality constraints and the lower, upper bounds on the variables x_{g}. The parameter θ_{q}>0 is chosen to satisfy the following condition θ_{q}+2θ*>0 where θ* is the optimal value of the equality constrained optimization problem

$$min {\sum }_{g ∈ 𝒢} {q}_{g}^{T} {x}_{g} + \frac{1}{2} {x}_{g}^{T} {Q}_{g} {x}_{g} \qquad ( 27 )$$

$$a . s . t . {A}_{g} {x}_{g} = {b}_{g} ∀ g ∈ 𝒢$$

$${\sum }_{g} {B}_{g} {x}_{g} = f$$

The optimization problem in Eq (27) is well-defined and differ from Eq (25) in that the bounds on the variables which are the inequalities are ignored.

The reformulation in Eq (26) is an optimization problem that is always feasible. For instance, the solution x_{g}=0, τ=0 is feasible to all the constraints. Hence, if Eq (25) is infeasible then any optimization algorithm applied to Eq (26) converges to the solution where all the variables are 0. On the other hand, if the optimization problem Eq (25) is feasible then application of any optimization algorithm to Eq (26) results in an optimal solution x_{g}*, τ* where τ*>0. Then the optimal solution to Eq (25) can be recovered as x_{g}*/τ*.

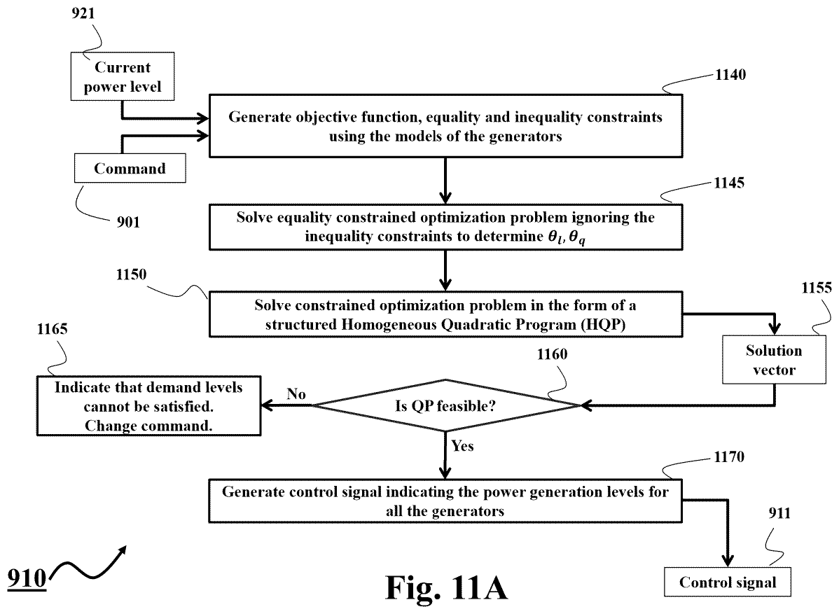

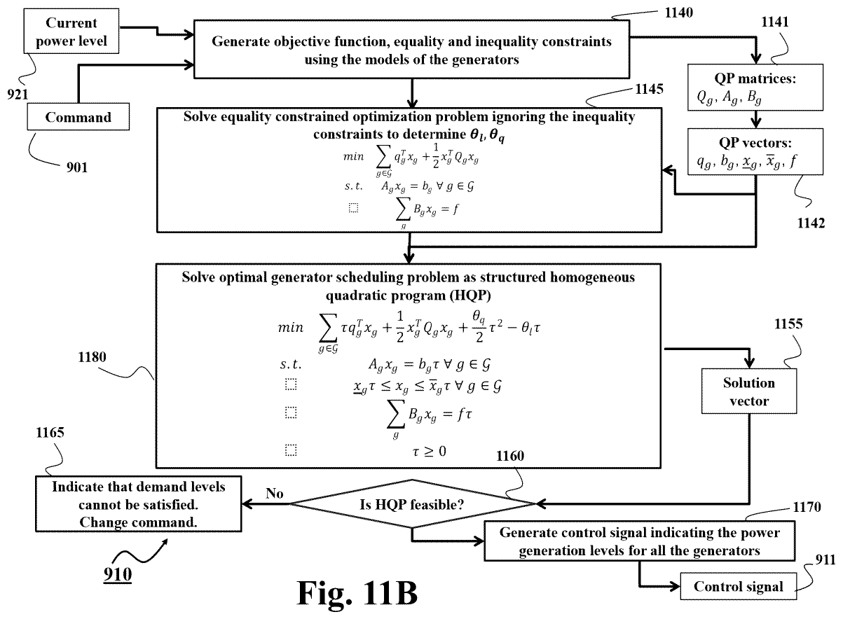

FIG. 11A shows a block diagram of a system and a method for QP based control to implement the controller 910 that computes the control signal 911, given the current power level of the system 921 and the control command 901 according to some embodiments. Specifically, an optimization-based controller computes a solution vector 1155 that contains a sequence of future optimal or approximately optimal power generation levels over a prediction time horizon of the system 1160, by solving a structured Homogeneous Quadratic Program (HQP) 1150, obtained from computing certain parameters 1145, at each control time step. The data 1145 of the objective function, equality and inequality constraints in this optimization problem 1150 depends on the generator models, the system constraints 1140, the current state of the system 921, objectives of control, and the control command 901. The solution vector 1155 is then checked to see if the QP is feasible. If feasible, then the control signal 911 which is the power levels for each generator 1170 is obtained. If infeasible, then the operator is provided the input 1165 that the demand cannot be satisfied with the current generator limits and that the demand should be modified.

The typical optimization algorithm for solving the optimization problem in Eq (26) applies Newton's method to solve for a point satisfying the stationary conditions of Eq (26). Accordingly, the stationary conditions for Eq (26) or the necessary conditions for optimality can be written as

$${Q}_{q} {x}_{g} + {A}_{g}^{T} {λ}_{g} - {\underline{v}}_{g} + {\overline{v}}_{g} + {B}_{g}^{T} ζ + {q}_{g} τ = 0 \qquad ( 28 )$$

$${A}_{g} {x}_{g} - {b}_{g} τ = 0$$

$$( {x}_{g} - {\underline{x}}_{g} τ ) ∘ {\underline{v}}_{g} = 0$$

$$i . ( {\overline{x}}_{g} τ - {x}_{g} ) ∘ {\overline{v}}_{g} = 0$$

$${\sum }_{g} {B}_{g} {x}_{g} - f τ = 0$$

$${\sum }_{g ∈ 𝒢} ( {q}_{g}^{T} {x}_{g} - {b}_{g}^{T} {λ}_{g} + {\underline{x}}_{g}^{T} {\underline{v}}_{g} - {\overline{x}}_{g}^{T} {\overline{v}}_{g} ) - {f}^{T} ζ + {θ}_{q} τ - ω = {θ}_{l}$$

$$τω = 0$$

where λ_{g} are multipliers for the constraints A_{g}x_{g}=b_{g}τ, v_{g}, v̅_{g} are nonnegative multipliers for the constraints x_{g}τ−x_{g}≤0, x̅_{g}−x̅_{g}τ≤0 respectively, (are multipliers for the coupling constraints Σ_{g}B_{g}x_{g}=fτ, and ω is a nonnegative multiplier for the nonnegative bound on T. The notation ∘ denotes elementwise multiplication between two vectors.

In one embodiment, an Interior Point Method (IPM) is employed to solve the for a zero of Eq (28). Specifically, the IPM obtains a step by applying Newton's method to the following system

$${F}_{μ}^{ipm} ( x , λ , \underline{v} , \overline{v} , ζ , τ , ω ) = 0$$

where μ>0 is a parameter that is determined as part of the IPM algorithm, x, λ, v, v̅ denotes the collection of x_{g}, λ_{g}, v_{g}, v̅_{g}, and

$$( 29 )$$

$${F}_{μ}^{ipm} ( x , λ , \underline{v} , \overline{v} , ζ , τ , ω ) = ( \begin{matrix}{Q}_{q} {x}_{g} + {A}_{g}^{T} {λ}_{g} - {\underline{v}}_{g} + {\overline{v}}_{g} + {B}_{g}^{T} ζ + {q}_{g} τ \\ {A}_{g} {x}_{g} - {b}_{g} τ \\ ( {x}_{g} - {\underline{x}}_{g} τ ) ∘ {\underline{v}}_{g} - μ {1}_{g} \\ ( {\overline{x}}_{g} τ - {x}_{g} ) ∘ {\overline{v}}_{g} - μ {1}_{g} \\ {\sum }_{g} {B}_{g} {x}_{g} - f τ \\ {\sum }_{g} {q}_{g}^{T} {x}_{g} - {b}_{g}^{T} {λ}_{g} - {\underline{x}}_{g}^{T} {\underline{v}}_{g} + {\overline{x}}_{g}^{T} {\overline{v}}_{g} - {f}^{T} ζ + {θ}_{q} τ - ω - {θ}_{l} \\ τ ω - μ\end{matrix} )$$

where 1_{g} is a vector of all ones of appropriate dimension. The IPM algorithm satisfies inequalities in Eq (26) by choosing an initial iterate that satisfies them strictly and enforcing this at every iteration of the algorithm. Similarly, the nonnegativity on multipliers v, v̅, ω is enforced at every iteration of the algorithm. A prototypical IPM algorithm can be described as below:

### IPM Algorithm

Choose x⁰, λ⁰, v⁰, v̅⁰, ζ⁰, τ⁰, ω⁰ such that v⁰, v̅⁰, ω⁰>0, and x_{g}τ⁰<x_{g}⁰<x̅_{g}τ⁰, τ⁰>0.

For k=0, 1, 2, . . . do
a. Choose a μk
b. Apply Newton's method on

$${F}_{{μ}^{k}}^{i p m} ( x , λ , \underline{v} , \overline{v} , ζ , τ , ω ) = 0$$

to determine the direction Δx^{k}, Δλ^{k}, Δv^{k}, Δv̅^{k}, Δζ^{k}, Δτ^{k}, Δω^{k}.
c. Find a step-length α^{k}∈[0,1] so that

$$i . {\underline{v}}^{k} + {α}^{k} Δ {\underline{v}}^{k} , {\overline{v}}^{k} + {α}^{k} Δ {\overline{v}}^{k} , {ω}^{k} + {α}^{k} Δ {ω}^{k} > 0$$

$$ii . {\underline{x}}_{g} ( {τ}^{k} + {α}^{k} Δ {τ}^{k} ) < ( {x}_{g}^{k} + {α}^{k} Δ {x}_{g}^{k} ) < {\overline{x}}_{g} ( {τ}^{k} + {α}^{k} Δ {τ}^{k} ) , {τ}^{0} > 0$$

d. Set (x^{k+1}, λ^{k+1}, v^{k+1}, v̅^{k+1}, ζ^{k+1}, τ^{k+1}, ω^{k+1})=(x^{k}, λ^{k}, v^{k}, v̅^{k}, ζ^{k}, τ^{k}, ω^{k})+α^{k}(Δx^{k}, Δλ^{k}, Δv^{k}, Δv̅^{k}, Δζ^{k}, Δτ^{k}, Δω^{k}).

The linear system involved in the Newton step computation takes the form

$${Q}_{g} Δ {x}_{g} + {A}_{g}^{T} Δ {λ}_{g} - Δ {\underline{v}}_{g} + Δ {\overline{v}}_{g} + {B}_{g}^{T} Δ ζ + {q}_{g} Δ τ = {r}_{d , g} \qquad ( 30 a )$$

$${A}_{g} Δ {x}_{g} - {b}_{g} Δ τ = {r}_{p , g} \qquad ( 30 b )$$

$${\underline{{W}_{g}}}_{, x} Δ {x}_{g} + {\underline{{W}_{g}}}_{, v} Δ {\underline{v}}_{g} - {\underline{{w}_{g}}}_{, τ} Δτ = - {\underline{{r}_{c}}}_{, g} \qquad ( 30 c )$$

$${\overline{W}}_{g , x} Δ {x}_{g} + {\overline{W}}_{g , v} Δ {\overline{v}}_{g} + {\overline{w}}_{g , τ} Δ τ = {\overline{r}}_{c , g} \qquad ( 30 d )$$

$${\sum }_{g} {B}_{g} Δ {x}_{g} - f Δ τ = {r}_{p , c} \qquad ( 30 e )$$

$${\sum }_{g} {q}_{g}^{τ} Δ {x}_{g} - {b}_{g}^{T} Δ {λ}_{g} - {\underline{x}}_{g}^{T} Δ {\underline{v}}_{g} + {\overline{x}}_{g}^{T} Δ {\overline{v}}_{g} - {f}^{T} Δ ζ + {θ}_{q} Δτ - Δ ω = {r}_{d , τ} \qquad ( 30 f )$$

$${w}_{τ} Δτ + {w}_{ω} Δ ω = {r}_{c , τ} \qquad ( 30 g )$$

where r_{d,g}, r_{p,g}, r_{c,g}, \dot{r}_{c,g}, r_{p,c}, r_{d,τ}, r_{c,τ} are the negative of the quantities on the left-hand side of Eq (29) evaluated at the iterate from which the step is computed. In the above, W_{g,x}, W_{g,v} are diagonal matrices with v_{g}, x_{g}−x_{g}τ respectively on the diagonal, W̅_{g,x}, W̅_{g,v} are diagonal matrices with v̅_{g}, x̅_{g}τ−x_{g} respectively on the diagonal, w_{g,τ}, w̅_{g,τ} are respectively x_{g}, x̅_{g}.

The equations in Eq(30) can be rewritten as

$$( \begin{matrix}{H}_{1} & & & {F}_{1}^{T} \\ & ⋱ & & ⋮ \\ & & {H}_{\vert 𝒢 \vert} & {F}_{\vert 𝒢 \vert}^{T} \\ {F}_{\vert 𝒢 \vert} & … & {F}_{\vert 𝒢 \vert} & D\end{matrix} ) ( \begin{matrix}Δ {v}_{1} \\ ⋮ \\ Δ {v}_{\vert 𝒢 \vert} \\ Δ z\end{matrix} ) = ( \begin{matrix}{r}_{1} \\ ⋮ \\ {r}_{\vert 𝒢 \vert} \\ {r}_{z}\end{matrix} ) \qquad ( 31 )$$

$$where$$

$${H}_{g} = ( \begin{matrix}{Q}_{g} & {A}_{g}^{T} & - I & I \\ {A}_{g} & & & \\ {\underline{{W}_{g}}}_{, x} & & {\underline{{W}_{g}}}_{, x} & \\ {\overline{W}}_{g , x} & & & {\overline{W}}_{g , v}\end{matrix} ) , {F}_{g}^{T} = ( \begin{matrix}{B}_{g}^{T} & {q}_{g} \\ & - {b}_{g} \\ & - {\underline{{w}_{g}}}_{, τ} \\ & {\overline{w}}_{g , τ}\end{matrix} ) , D = ( \begin{matrix} & - f & \\ - {f}^{T} & {θ}_{q} & - 1 \\ & {w}_{τ} & {w}_{ω}\end{matrix} ) .$$

$$and$$

$$Δ {v}_{g} = ( \begin{matrix}Δ {x}_{g} \\ {Δλ}_{g} \\ Δ {\underline{v}}_{g} \\ Δ {\overline{v}}_{g}\end{matrix} ) , Δ z = ( \begin{matrix}Δζ \\ Δ τ \\ Δω\end{matrix} ) , {r}_{g} = ( \begin{matrix}{r}_{d , g} \\ {r}_{p , g} \\ {\underline{{r}_{c}}}_{, g} \\ {\overline{r}}_{c , g}\end{matrix} ) , {r}_{z} = ( \begin{matrix}{r}_{p , c} \\ {r}_{d , τ} \\ {r}_{c , τ}\end{matrix} ) .$$

A direct solution of the system in Eq (31) will accrue a cubic complexity in the number of generators. Instead, a decomposition method is described that scales linearly in the number of generators. In Eq (31), the step variables Δv_{g} represent the step in optimization variables in Eq (30) that are specific to the generator g, i.e. power generation level variables Δx_{g}, Δλ_{g} the step in the dual multipliers for the equality constraints modeling the operation of the generator, Δv_{g}, Δv̅_{g} the steps in the dual variables for the lower and upper bound constraints in the operation of the generator. The variable Δz represent the step in the variables in Eq (30) that correspond to the coupling constraints i.e. Δζ the step in the dual multipliers for the demand satisfaction constraints, Δτ, Δω the step in the homogenizing variable and its dual multipliers that are introduced in the HQP to robustly handle infeasibility of the QP.

From Eq (31) it is easy to see that for each g∈ [symbol] , Δv_{g} can be written in term of Δz as

$${H}_{g} Δ {v}_{g} = - {F}_{g}^{T} Δ z + {r}_{g} \qquad Eq ( 32 )$$

The last block row in Eq (31) is

$${\sum }_{g} {F}_{g} Δ {v}_{g} + D Δ z = {r}_{z} \qquad ( 33 )$$

From the structure of Eq (32) and (33), it is easy to devise the decomposition method for solving Eq (31).

Decomposition for computing Newton step

For each g∈ [symbol] , solve for the variables Δv_{g} in terms of Δz using Eq (32) as

$$a . Δ {v}_{g} = - {H}_{g}^{- 1} {F}_{g}^{T} Δ z + {H}_{g}^{- 1} {r}_{g} \qquad ( 34 )$$

Using the elimination in Step 1, substitute for Δv_{g} in Eq (32) to obtain

$$a . ( - {\sum }_{g} {F}_{g} {H}_{g}^{- 1} {F}_{g}^{T} + D ) Δ z = {r}_{z} - {\sum }_{g} {F}_{g} {H}_{g}^{- 1} {r}_{g} \qquad ( 35 )$$

Solve for variables Δz using the system obtained from Step 2.

Substitute for variables Δz back in Eq (33) to obtain Δv_{g} for each g∈ [symbol] .

In the above decomposition, Steps 1 and 4 can in fact be carried out in parallel. So the Newton step computation can be made even more efficient.

In Eq (34) the step in the generator's optimization variables Δv_{g} are expressed in terms of the coupling optimization variables Δz. This elimination of variables is substituted in Eq (33) to obtain a square system of linear equations that are only in the coupling variables Δz. This is then solved to obtain the step in the coupling variables which is then used to recover the step in the generator optimization variables.

Some embodiments use an interior point optimization method to solve the inequality constrained optimization problem 1150 either exactly or approximately, using an iterative procedure that is based on a Newton-type method in combination with a barrier-type relaxation to solve the resulting set of smooth necessary conditions of optimality. Some embodiments are based on the realization that the inequality constrained optimization problem 1150 has a structure that can be exploited in the newton step computation of an interior point optimization method and can be used to compute the solution vector 1155 at each control time step.

FIG. 11B shows a block diagram of a controller that solves a constrained optimal control structured homogeneous quadratic programming problem (HQP) 1180 in order to compute the control signal 911 at each control time step, given the current state of the system 921 and the command 901. Some embodiments are based on a constrained structured homogeneous quadratic programming problem (HQP) 1180 that needs to be solved at each control time step. The HQP depends on the parameters that are computed 1145 by solving the QP while ignoring the inequality constraints on the generators. Examples of the QP matrices 1141 include Hessian matrices, e.g., Q_{g}, and constraint Jacobian matrices, e.g., A_{g}, B_{g}. Examples of the QP vectors 1142 include gradient vectors, e.g., q_{g}, b_{g}, x̅_{g}, x_{g} and f.

FIG. 12A illustrates the approach of an interior point optimization algorithm to solve the structured homogeneous quadratic programming problem (HQP) 1170, in some embodiments, by iteratively solving a smoothened system of necessary optimality conditions using a Newton-type solution strategy for a converging sequence of barrier relaxation parameter values 1200.

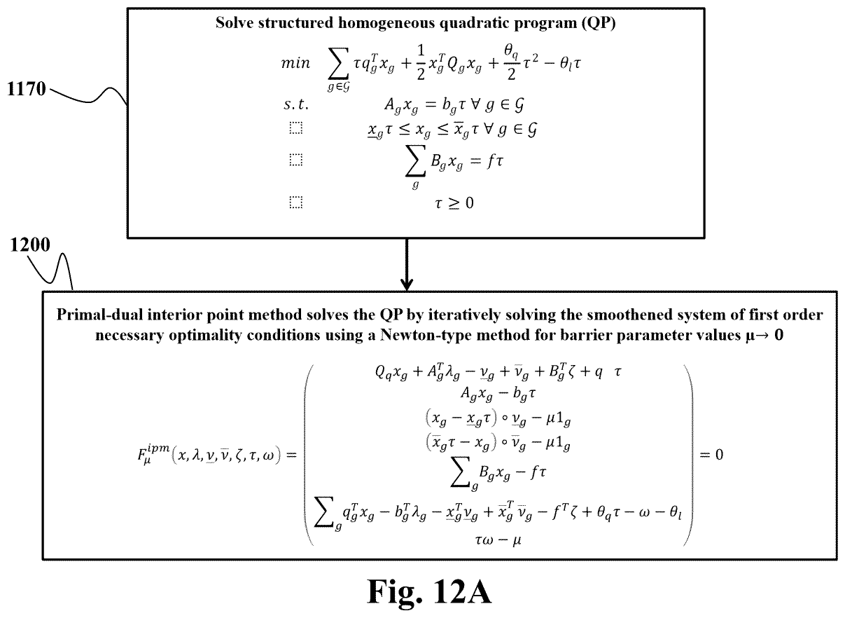

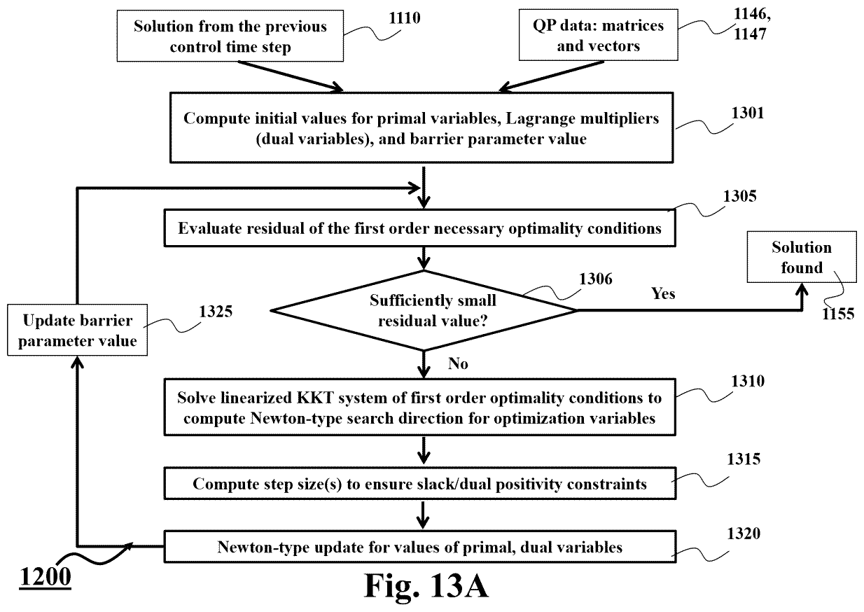

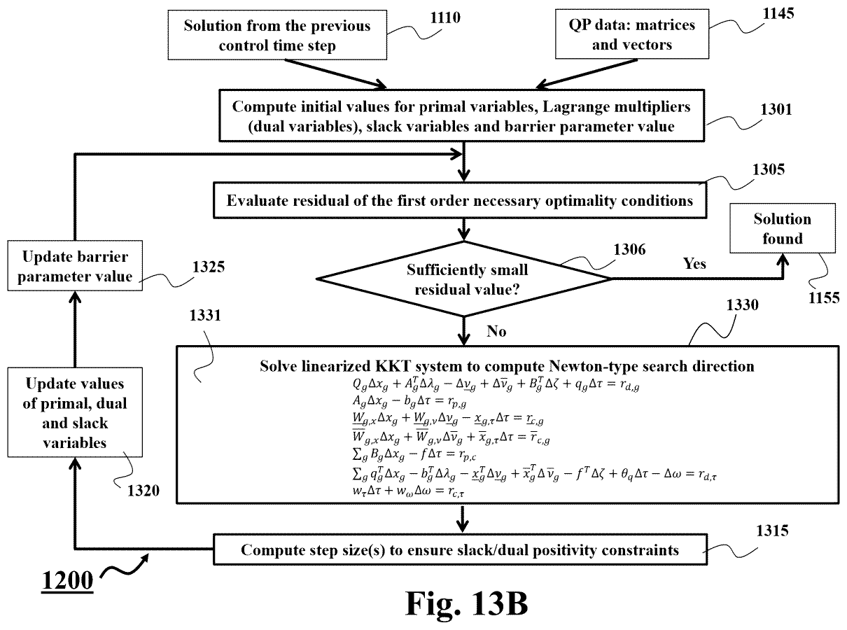

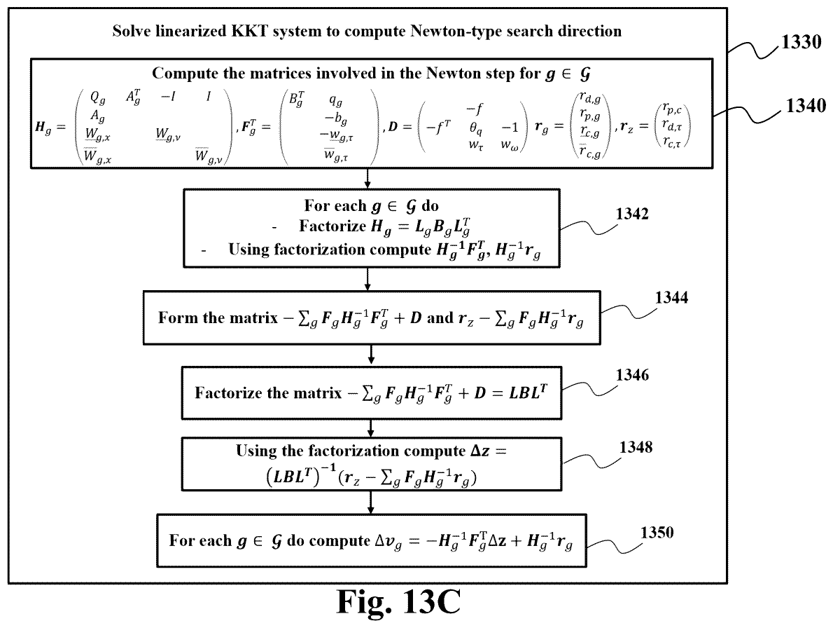

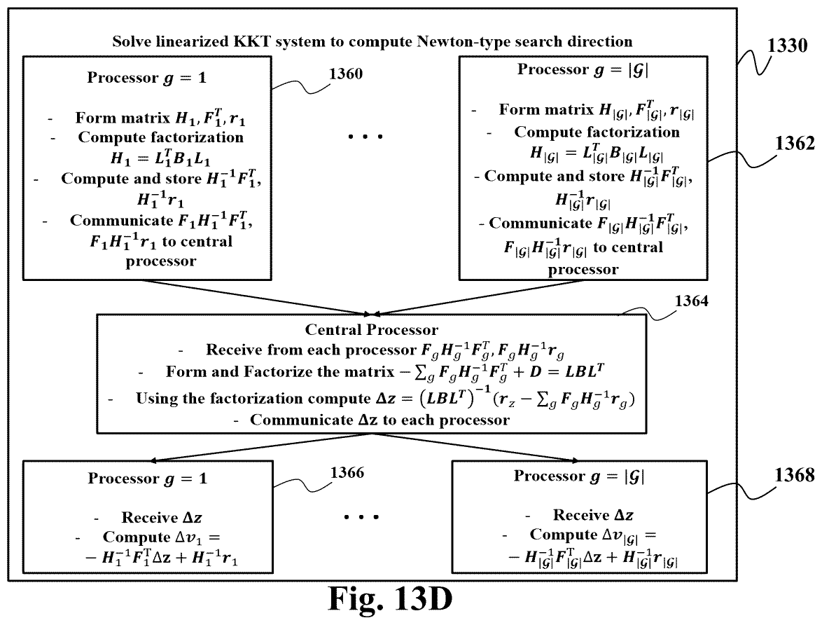

FIG. 13A shows a block diagram of the initialization step and the iterative procedure of an interior point optimization algorithm to solve HQP in an implementation of the control system 1200. The initialization step can use the optimal or approximate solution from the previous control time step 1110 and/or the QP data 1146, 1147 to compute initial values for the primal optimization variables, the Lagrange multipliers (dual variables) with respect to equality and inequality constraints, the slack variables for the inequality constraints and an initial barrier parameter value 1301.

Based on the initialization of the values for the optimization variables 1301, an iterative procedure of the interior point optimization algorithm aims to make the residual value of the first order necessary optimality conditions sufficiently small 1306, in which case the (approximately) optimal solution is found 1155. The iterative procedure starts by evaluating the residual vector of the first order necessary optimality conditions 1305, and it then checks whether a norm of the residual vector is sufficiently small with respect to a tolerance value 1306. The (approximately) optimal solution is found 1155 and the iterative procedure terminates if the residual value is sufficiently small but the iterative procedure continues if a norm of the residual vector is too large and the number of iterations of the interior point optimization algorithm has not yet reached a maximum value.

The iterative procedure of the interior point optimization algorithm 1200 continues by solving a linearized system of Karush-Kuhn-Tucker (KKT) conditions, further referred to as a linearized KKT system, for the set of first order optimality conditions to compute a Newton-type search direction 1310 for the optimal values of the optimization variables in the constrained optimal control problem for an implementation of the predictive control system. Next, the iterative procedure computes a step size in the Newton-type search direction that ensures the positivity of the slack variables and of the Lagrange multipliers (dual variables) with respect to the inequality constraints 1315. In some embodiments, the step size is computed as the largest positive value that is smaller than one in the Newton-type search direction that ensures the positivity of the slack variables and of the Lagrange multipliers with respect to the inequality constraints 1315.

Based on the Newton-type search direction 1310 and the computed step size 1315, the iterative procedure of the interior point optimization algorithm continues by updating the values for the primal optimization variables, for the Lagrange multipliers (dual variables) and for the slack variables 1320. Given the new solution guess for the optimization variables, an update to the barrier parameter value 1325 can be computed such that the new residual vector of the first-order necessary optimality conditions 1305 can be evaluated. The iterative procedure of the interior point optimization algorithm continues until the residual value is sufficiently small 1306, and the (approximately) optimal solution is found 1155, or until a maximum number of interior point iterations has been reached.

FIG. 13B shows a block diagram of the linearized KKT system to compute a Newton-type search direction 1330 in the iterative procedure of an interior point optimization algorithm to solve HQP according to some embodiments. The linearized system can be represented as a block-structured linear system of equations 1331 that defines the Newton-type search direction for the primal optimization variables, the dual variables in the k^{th} iteration of the interior point optimization algorithm. The right-hand side vector of the linear KKT system 1331 consists of the evaluation of the stationarity conditions in the k^{th} iteration of the interior point optimization algorithm.

Some embodiments are based on the realization that the relaxed complementarity conditions 1335, for a nonzero barrier parameter value μ^{k}>0, correspond more closely to the exact complementarity conditions for increasingly small values of the barrier parameter μ^{k}→0 for successive iterations of the interior point optimization algorithm.

FIG. 13C shows a block diagram of a decomposition of the linearized KKT system to compute a Newton-type search direction. The matrices H_{g},

$${F}_{g}^{T} ,$$

D and the vectors r_{g}, z 1340. Then the matrices H_{g} are factorized 1342 to compute

$${H}_{g}^{- 1} {F}_{g}^{T} , {H}_{g}^{- 1} {r}_{g}$$

in sequence for each g. Then, the computed matrices are combined 1344 to produce a matrix of the coupled system which is then factorized 1346. This factorization 1346 is used to compute the step Δz 1348. This step is then used to recover the step Δv_{g} 1350. The combination of Δv_{g} and Δz allows recovery of the Newton step.

FIG. 13D shows a block diagram of a decomposition of the linearized KKT system to compute a Newton-type search direction where parallel computations are realized to further reduce the computation time for the Newton step. The matrices H_{g},

$${F}_{g}^{T} ,$$

D and the vectors r_{g}, z 1360, 1362 are computed in parallel. Further the matrices H_{g} are factorized 1360, 1362 to compute

$${H}_{g}^{- 1} {F}_{g}^{T} , {H}_{g}^{- 1} {r}_{g}$$

in parallel for each g. Then, the computed matrices and vectors are communicated to a central processor 1364 where they are combined 1364 to produce a matrix of the coupled system which is then factorized. This factorization 1364 is used to compute the step Δz. This step is then used to recover the step Δv_{g} 1366, 1368 which also executed in parallel. The combination of Δv_{g} and Δz allows recovery of the Newton step.

In another embodiment, a Semismooth Newton Method (SNM) is employed to solve the for a zero of Eq (28). Specifically, the SNM obtains a step by applying Newton's method to the following system

$${F}^{snm} ( x , λ , \underline{v} , \overline{v} , ζ , τ , ω ) = 0$$

where x, λ, v, v̅ denotes the collection of x_{g}, λ_{g}, v_{g}, v̅g, and

$${F}^{snm} ( x , λ , \underline{v} , \overline{v} , ζ , τ , ω ) = ( \begin{matrix}{Q}_{q} {x}_{g} + {A}_{g}^{T} {λ}_{g} - {\underline{v}}_{g} + {\overline{v}}_{g} + {B}_{g}^{T} ζ + {q}_{g} τ \\ {A}_{g} {x}_{g} - {b}_{g} τ \\ Φ ( {x}_{g} - {\underline{x}}_{g} τ , {\underline{v}}_{g} ) \\ Φ ( {\overline{x}}_{g} τ - {x}_{g} , {\overline{v}}_{g} ) \\ {\sum }_{g} {B}_{g} {x}_{g} - f τ \\ {\sum }_{g} {q}_{g}^{T} {x}_{g} - {b}_{g}^{T} {λ}_{g} - {\underline{x}}_{g}^{T} {\underline{v}}_{g} + {\overline{x}}_{g}^{T} {\overline{v}}_{g} - {f}^{T} ζ + {θ}_{q} τ - ω - {θ}_{l} \\ ϕ ( τ , ω )\end{matrix} ) \qquad ( 36 )$$

where ϕ(a, b)=−a−b+\sqrt{a²+b²} for scalars a, b and Φ(a, b)=(ϕ(a₁, b₁), . . . , ϕ(aₙ, bₙ)) for vectors a, b. A prototypical SNM algorithm can be described as below:

### SNM Algorithm

Choose x⁰, λ⁰, v⁰, v̅⁰, ζ⁰, τ⁰, ω⁰.

For k=0, 1, 2, . . . do
a. Apply Newton's method on F^{snm}(x, λ, v, v̅, ζ, τ, ω)=0 to determine the direction Δx^{k}, Δλ^{k}, Δv^{k}, Δv̅^{k}, Δζ^{k}, Δτ^{k}, Δω^{k}.
b. Find a step-length α^{k}∈[0,1] so that

$$i . ‖ {F}^{snm} ( ( {x}^{k} , {λ}^{k} , {\underline{v}}^{k} , {\overline{v}}^{k} , {ζ}^{k} , {τ}^{k} , {ω}^{k} ) + {α}^{k} ( Δ {x}^{k} , Δ {λ}^{k} , Δ {\underline{v}}^{k} , Δ {\overline{v}}^{k} , {Δζ}^{k} , {Δτ}^{k} , {Δω}^{k} ) ) ‖ \leq ‖ {F}^{snm} ( ( {x}^{k} , {λ}^{k} , {\underline{v}}^{k} , {\overline{v}}^{k} , {ζ}^{k} , {τ}^{k} , {ω}^{k} ) ) ‖$$

$$c . Set ( {x}^{k + 1} , {λ}^{k + 1} , {\underline{v}}^{k + 1} , {\overline{v}}^{k + 1} , {ζ}^{k + 1} , {τ}^{k + 1} , {ω}^{k + 1} ) = ( {x}^{k} , {λ}^{k} , {\underline{v}}^{k} , {\overline{v}}^{k} , {ζ}^{k} , {τ}^{k} , {ω}^{k} ) + {α}^{k} ( Δ {x}^{k} , {Δλ}^{k} , Δ {\underline{v}}^{k} , Δ {\overline{v}}^{k} , {Δζ}^{k} , {Δτ}^{k} , {Δω}^{k} )$$

The following describes the decomposition method involved in the Newton step computation. As outlined earlier, the decomposition allows to compute the search direction in computational complexity that is linear in the number of generators. The linear system involved in the Newton step computation takes the form

$${Q}_{g} Δ {x}_{g} + {A}_{g}^{T} Δ {λ}_{g} - Δ {\underline{v}}_{g} + Δ {\overline{v}}_{g} + {B}_{g}^{T} Δ ζ + {q}_{g} Δ τ = {r}_{d , g} \qquad ( 37 a )$$

$${A}_{g} Δ {x}_{g} - {b}_{g} Δ τ = {r}_{p , g} \qquad ( 37 b )$$

$${\underline{W}}_{g , x} Δ {x}_{g} + {\underline{W}}_{g , v} Δ {\underline{v}}_{g} - {\underline{w}}_{g , τ} Δ τ = - {\underline{r}}_{c , g} \qquad ( 37 c )$$

$${\overline{W}}_{g , x} Δ {x}_{g} + {\overline{W}}_{g , v} Δ {\overline{v}}_{g} + {\overline{w}}_{g , τ} Δ τ = {\overline{r}}_{c , g} \qquad ( 37 d )$$

$${\sum }_{g} {B}_{g} Δ {x}_{g} - f Δ τ = {r}_{p , c} \qquad ( 37 e )$$

$${\sum }_{g} {q}_{g}^{T} Δ {x}_{g} - {b}_{g}^{T} Δ {λ}_{g} - {\underline{x}}_{g}^{T} Δ {\underline{v}}_{g} + {\overline{x}}_{g}^{T} Δ {\overline{v}}_{g} - {f}^{T} Δ ζ + {θ}_{q} Δ τ - Δ ω = {r}_{d , τ} \qquad ( 37 f )$$

$${w}_{τ} Δ τ + {w}_{ω} Δ ω = {r}_{c , τ} \qquad ( 37 g )$$

where r_{d,g}, r_{p,g}, r_{c,g}, r̅_{c,g}, r_{p,c}, r_{d,τ}, r_{c,τ} are the negative of the quantities on the left-hand side of Eq (35) evaluated at the iterate from which the step is computed. In the above, W_{g,x}, W_{g,v}, w_{g,τ} are represent ∇ₓ_{_{g}}Φ(x_{g}−x_{g}τ, v_{g}), ∇ᵥ_{_{g}}Φ(x_{g}−x_{g}τ, v_{g}), ∇_{τ}Φ(x_{g}−x_{g}τ, v_{g}) respectively on the diagonal, W̅_{g,x}, W̅_{g,v}, w̅_{g,τ} represent ∇ₓ_{_{g}}Φ(x̅_{g}τ−x_{g}, v̅_{g}), ∇_{v̅}_{_{g}}Φ(x̅_{g}τ−x_{g}, v̅_{g}), ∇_{τ}Φ(x̅_{g}τ−x_{g}, v̅_{g}).

Eq (37) is identical in structure to that of Eq (30). The steps outlined for the solution of the system in Eq (30) and the decomposition method can readily be applied to the system in Eq (37). Thus, the SNM can be solved using an algorithm in which the cost of each iteration scales linearly in the number of generators.

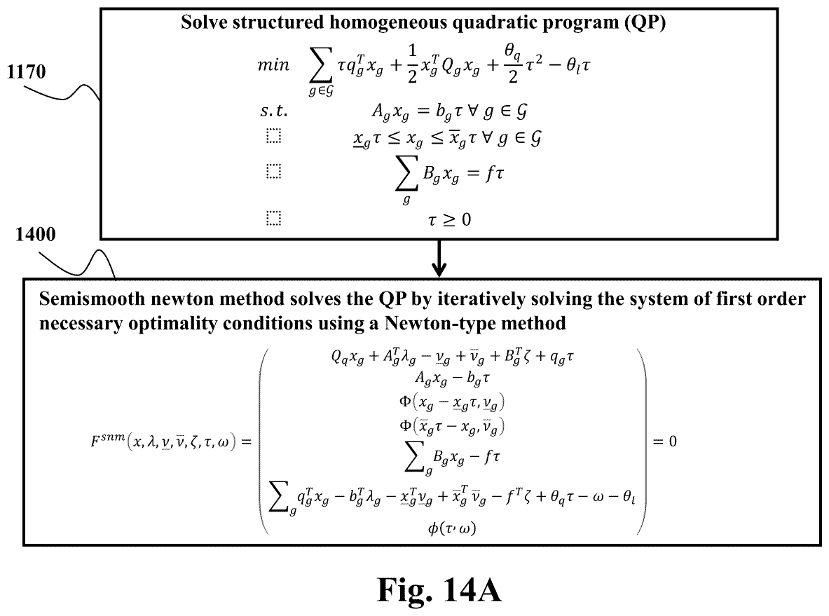

FIG. 14A illustrates the approach of a semismooth newton method algorithm to solve the structured homogeneous quadratic programming problem (HQP) 1170, in some embodiments, by iteratively solving a smoothened system of necessary optimality conditions using a Newton-type solution strategy for a converging sequence of barrier relaxation parameter values 1400.

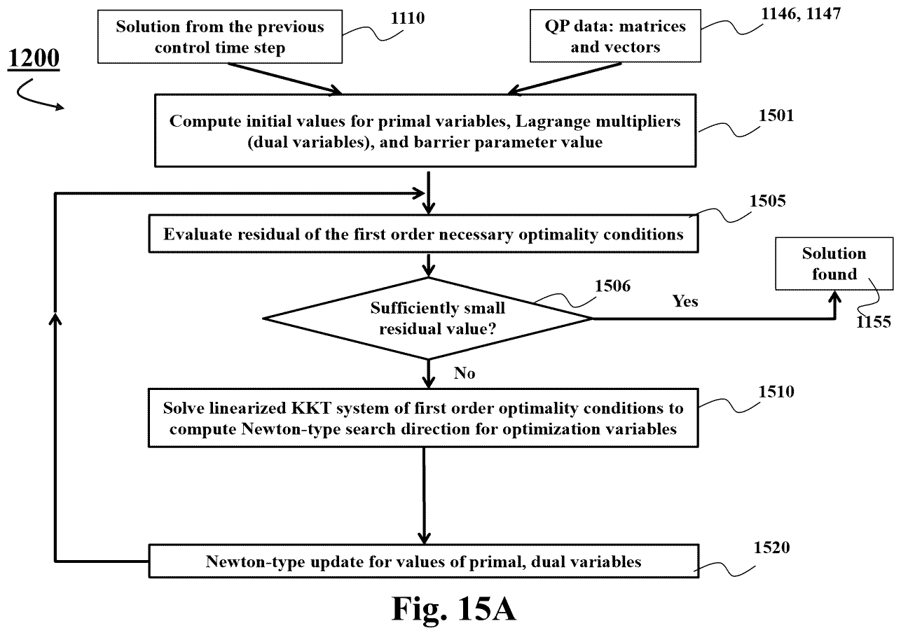

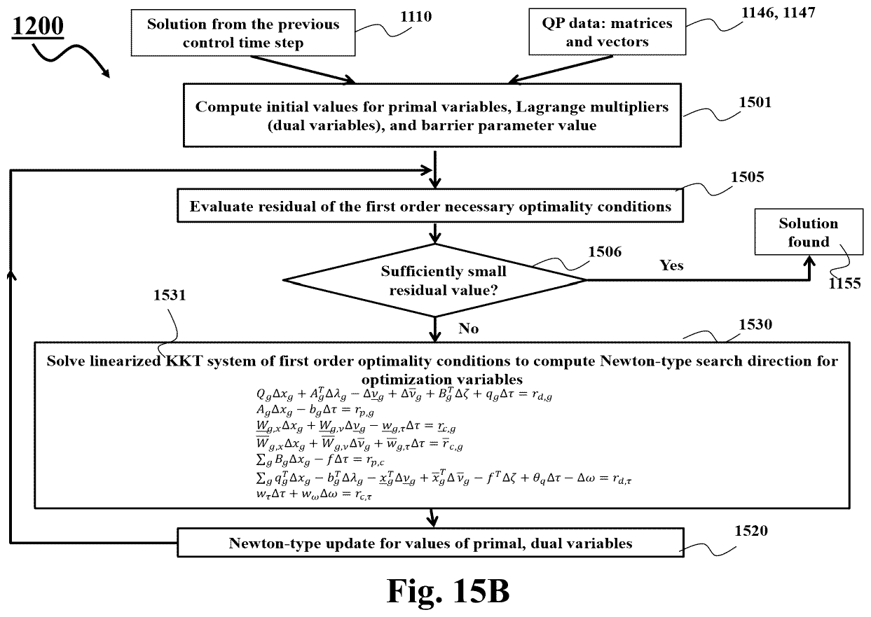

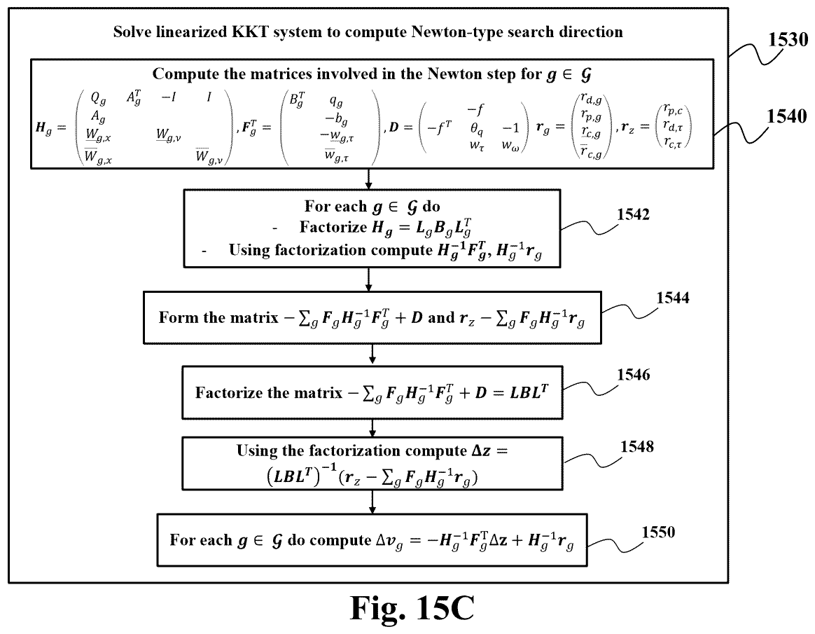

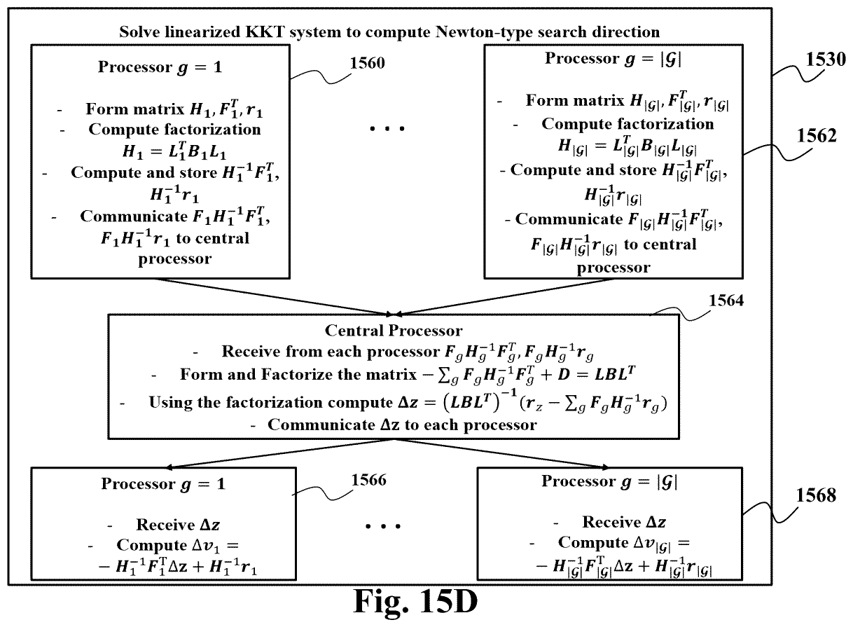

FIG. 15A shows a block diagram of the initialization step and the iterative procedure of an semismooth newton method algorithm to solve HQP in an implementation of the control system 1200. The initialization step can use the optimal or approximate solution from the previous control time step 1110 and/or the QP data 1146, 1147 to compute initial values for the primal optimization variables, the Lagrange multipliers (dual variables) with respect to equality and inequality constraints, the slack variables for the inequality constraints and an initial barrier parameter value 1501.

Based on the initialization of the values for the optimization variables 1501, an iterative procedure of the semismooth newton method algorithm aims to make the residual value of the first order necessary optimality conditions sufficiently small 1506, in which case the (approximately) optimal solution is found 1155. The iterative procedure starts by evaluating the residual vector of the first order necessary optimality conditions 1505, and it then checks whether a norm of the residual vector is sufficiently small with respect to a tolerance value 1506. The (approximately) optimal solution is found 1155 and the iterative procedure terminates if the residual value is sufficiently small but the iterative procedure continues if a norm of the residual vector is too large and the number of iterations of the interior point optimization algorithm has not yet reached a maximum value.

The iterative procedure of the semismooth newton method algorithm 1200 continues by solving a linearized system of Karush-Kuhn-Tucker (KKT) conditions, further referred to as a linearized KKT system, for the set of first-order optimality conditions to compute a Newton-type search direction 1510 for the optimal values of the optimization variables in the constrained optimal control problem for an implementation of the control system.

Based on the Newton-type search direction 1510, the iterative procedure of the semismooth newton method algorithm continues by updating the values for the primal optimization variables, for the Lagrange multipliers (dual variables) and for the slack variables 1520. Given the new solution guess for the optimization variables, the new residual vector of the first order necessary optimality conditions 1505 can be evaluated. The iterative procedure of the semismooth newton method algorithm continues until the residual value is sufficiently small 1506, and the (approximately) optimal solution is found 1155, or until a maximum number of interior point iterations has been reached.

FIG. 15B shows a block diagram of the linearized KKT system to compute a Newton-type search direction 1330 in the iterative procedure of an semismooth newton method algorithm to solve HQP according to some embodiments. The linearized system can be represented as a block-structured linear system of equations 1331 that defines the Newton-type search direction for the primal optimization variables, the dual variables in the k^{th} iteration of the semismooth newton method algorithm. The right-hand side vector of the linear KKT system 1531 consists of the evaluation of the stationarity conditions in the k^{th} iteration of the semismooth newton method algorithm.

FIG. 15C shows a block diagram of a decomposition of the linearized KKT system to compute a Newton-type search direction in the semismooth newton method algorithm. The matrices H_{g},

$${F}_{g}^{T} ,$$

D and the vectors r_{g}, r_{z} 1540. Then the matrices H_{g} are factorized 1542 to compute

$${H}_{g}^{- 1} {F}_{g}^{T} , {H}_{g}^{- 1} {r}_{g}$$

in sequence for each g. Then, the computed matrices are combined 1544 to produce a matrix of the coupled system which is then factorized 1546. This factorization 1546 is used to compute the step Δz 1548. This step is then used to recover the step Δv_{g} 1550. The combination of Δv_{g} and Δz allows recovery of the Newton step.

FIG. 15D shows a block diagram of a decomposition of the linearized KKT system to compute a Newton-type search direction where parallel computations are realized to further reduce the computation time for the Newton step. The matrices H_{g},

$${F}_{g}^{T} ,$$

D and the vectors r_{g}, r_{z} 1560, 1562 are computed in parallel. Further the matrices H_{g} are factorized 1560, 1562 to compute

$${H}_{g}^{- 1} {F}_{g}^{T} , {H}_{g}^{- 1} {r}_{g}$$

in parallel for each g. Then, the computed matrices and vectors are communicated to a central processor 1564 where they are combined 1564 to produce a matrix of the coupled system which is then factorized. This factorization 1564 is used to compute step Δz. This step is then used to recover the step Δv_{g} 1566, 1568 which also executed in parallel. The combination of Δv_{g} and Δz allows recovery of the Newton step.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, and any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, es.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A controller for controlling an operation of an electric grid including a plurality of generators, the controller comprising: a memory configured to store executable instructions; and a processor configured to execute the executable instructions to cause the controller to:
collect a feedback signal indicative of a current state of the operation of the electric grid and a total demand of power from the plurality of generators of the electric grid;
formulate an original quadratic program (QP) for optimizing an objective function subject to equality constraints and inequality constraints on one or a combination of state and control variables of the operation of the electric grid based on the total demand and the current state of the operation of the electric grid;
lift the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space;
transform the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation;
solve the homogeneous QP to produce a solution in the lifted space using a decomposition that replaces variables corresponding to individual generators with dual variables corresponding to the total demand of power, the additional nonnegative variable, and a dual variable corresponding to the additional nonnegative variable;
control the electric grid according to an infeasibility protocol when a value of the additional non-negative variable in the solution in the lifted space equals zero; and otherwise
project the solution in the lifted space into the original space using a projection operation reversing the lifting operation to produce a solution of the original QP; and
control the electric grid using a control command determined based on the solution of the original QP.

2. The controller of claim 1, wherein the processor includes a central processor operatively connected to a plurality of processors of the generators to produce the control command using parallel computations of the plurality of processors enabled by the decomposition.

3. The controller of claim 1, wherein, the HQP is solved iteratively, wherein for each iteration, the processor is further configured to:
execute a Newton Method with the decomposition using at least one of an Interior Point Method (IPM) or a Semi-smooth Newton Method (SNM) to find a direction for updating variables of the HQP; and
update the variables along the direction.

4. The controller of claim 3, wherein, to execute the IPM in a current iteration, the processor is further configured to:
compute a first value of (i) the generator variables, (ii) the dual variables, (iii) the slack variables, (iv) a barrier parameter value, (v) or a combination thereof;
determine, a first residual value of the first order optimality conditions based on the computed first value of (i) the generator variables, (ii) the dual variables, (iii) the slack variables, (iv) the barrier parameter value, (v) or a combination thereof;
solve, based on a determination that the first residual value is less than a tolerance value, a linearized Karush-Kuhn-Tucker (KKT) matrix of the first optimality conditions to compute a first Newton-type search direction;
compute a first step size in the first Newton-type search direction, wherein the first step size satisfy positivity constraints on the dual variables and the slack variables for each of the inequality constraints;
iteratively update the first value of the (i) the generator variables, (ii) the dual variables; (iii) the slack variables, (iv) the barrier parameter value, (v) or a combination thereof until a determination of a second residual value based on the first Newton-type search direction and the computed first step size, wherein the determined second residual value is greater than the tolerance value; and
determine, based on the second residual value, the solution of the homogeneous QP.

5. The controller of claim 4, wherein, based on a determination that the first residual value is less than the tolerance value, the processor is further configured to execute the executable instructions to cause the controller to:
determine, based on the first residual value, the solution of the homogenous QP.

6. The controller of claim 4, wherein, to apply the decomposition method, the processor is further configured to execute the executable instructions to cause the controller to:
compute, based on the linearized KKT matrix, a set of matrices associated with a current Newton step for each generator of the plurality of generators and a set of vectors wherein the set of matrices includes at least (i) generator step variable associated with each generator of the plurality of generators, and (ii) coupling step variable associated with constraints of the homogeneous QP,
factorize the set of matrices corresponding to the generator variable or the coupling step variable to compute a set of factorized matrices, wherein the set of matrices include at least a first factorized matrix and a second factorized matrix;
solve, based on the first factorized matrix, the generator variable corresponding to the coupling step variable to factorize the generator variable;
substitute the factorized generator variable into the first factorized matrix to obtain a third factorized matrix, wherein the third factorized matrix corresponds to a set of square system of linear equations in the step for the coupling step variable;
solve, based on the third factorized matrix, the coupling step variable; and
substitute the solved coupling step variable into the second factorized matrix to compute the generator step variable.

7. The controller of claim 6, wherein the generator step variable indicative of (i) a step in the power generation level variables of each generator of the plurality of generators, (ii) a step in the dual variables for the equality constraints model an operation of the plurality of generators; (iii) a step in the dual variables for the lower constraints in the operation of the plurality of generators, and (iv) a step in the dual variables for the upper constraints in the operation of the plurality of generators.

8. The controller of claim 6, wherein the coupling step variable indicative of (i) a step in constraint variables that correspond to coupling constraints, (ii) a step in the dual variables for the demand satisfaction constraints, and (iii) a step in homogenizing variables and corresponding dual variables associated with the homogenous QP.

9. The controller of claim 6, wherein, to substitute the factorized generator variable into the first factorized matrix, the processor is further configured to execute the executable instructions to cause the controller to:
substitute, based on the first factorized matrix, the step in the power generation level variables of each generator of the plurality of generators, the step in the dual variables for the equality constraints model the operation of the plurality of generators with respect to the step in constraint variables that correspond to the coupling constraints, the step in the dual variables for the demand satisfaction constraints, and the step in the homogenizing variables and the corresponding dual variables associated with the homogenous QP.

10. The controller of claim 6, wherein, to compute the generator step variable, the processor is further configured to execute the executable instructions to cause the controller to:
substitute the step in constraint variables that correspond to coupling constraints, the step in the dual variables for the demand satisfaction constraints, and a step in homogenizing variables and corresponding dual variables associated with the homogenous QP with respect to the step in the power generation level variables of each generator of the plurality of generators, the step in the dual variables for the equality constraints model the operation of the plurality of generators, the step in the dual variables for the lower constraints in the operation of the plurality of generators, and the step in the dual variables for the upper constraints in the operation of the plurality of generators.

11. The controller of claim 1, wherein the lifting operation includes multiplication of values in the original space by the additional non-negative variable.

12. The controller of claim 1, wherein the processor is further configured to execute the executable instructions to cause the controller to:
lift the equality constraints in the lifted space by scaling the equality constraints with the additional non-negative variable, and wherein the solution in the lifted space is projected to the original space by dividing the solution in the lifted space with the additional non-negative variable.

13. The controller of claim 1, wherein the processor is further configured to execute the executable instructions to cause the controller to:
transform the original QP such that the solution of the homogeneous QP in the lifted space is negative for positive values of the additional non-negative variable.

14. The controller of claim 1, wherein the homogeneous QP includes a quadratic term of the original QP, a linear term of the original QP scaled by the additional non-negative variable, a quadratic term of the additional non-negative variable scaled by a scalar selected to be greater than two times the negative of the lower bound of the original QP and a negative linear term of the additional non-negative variable.

15. The controller of claim 1, wherein the first-order optimality conditions of the homogeneous QP correspond to the first-order optimality conditions of the original QP lifted in the higher space by the lifting operation, and wherein the projection operation transforms a solution of the first-order conditions of the homogeneous QP whenever the additional non-negative variable is positive, to satisfy the first-order conditions of the original QP.

16. The controller of claim 1, wherein the processor is further configured to execute the executable instructions to cause the controller to control, based on the control command, at least one generator of the plurality of generators to change a current amount of produced power to satisfy the total demand of power.

17. The controller of claim 1, wherein the processor is further configured to execute the executable instructions to cause the controller to control, based on the control command, an engine speed of the at least one generator of the plurality of generator to change the current amount of produced power to satisfy the total demand of power.

18. The controller of claim 2, wherein the processor is further configured to execute the executable instructions to cause the controller to:
determine, based on the infeasibility protocol, an amount of power to satisfy the total demand of power;
control the electric grid to obtain the determined amount of power produced from one or more power sources.

19. A method for controlling an operation of an electric grid including a plurality of generators, the method comprising:
collecting a feedback signal indicative of a current state of the operation of the electric grid and a total demand of power from the plurality of generators of the electric grid;
formulating an original quadratic program (QP) for optimizing an objective function subject to equality constraints and inequality constraints on one or a combination of state and control variables of the operation of the electric grid based on the total demand and the current state of the operation of the electric grid;
lifting the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space;
transforming the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation;
solving the homogeneous QP to produce a solution in the lifted space using a decomposition that replaces variables corresponding to individual generators with dual variables corresponding to the total demand of power, the additional nonnegative variable, and a dual variable corresponding to the additional nonnegative variable;
controlling the electric grid according to an infeasibility protocol when a value of the additional non-negative variable in the solution in the lifted space equals zero; and otherwise
projecting the solution in the lifted space into the original space using a projection operation reversing the lifting operation to produce a solution of the original QP; and
controlling the electric grid using a control command determined based on the solution of the original QP.

20. A non-transitory computer-readable storage medium embodied thereon a program executable by a processor for performing a method for controlling an operation of an electric grid including a plurality of generators, the method comprising:
collecting a feedback signal indicative of a current state of the operation of the electric grid and a total demand of power from the plurality of generators of the electric grid;
formulating an original quadratic program (QP) for optimizing an objective function subject to equality constraints and inequality constraints on one or a combination of state and control variables of the operation of the electric grid based on the total demand and the current state of the operation of the electric grid;
lifting the equality constraints and the inequality constraints into a lifted space having a dimension higher than a dimension of an original space of the original QP by a lifting operation introducing an additional non-negative variable such that a subspace defined by the equality constraints in the lifted space intersects a subspace defined by the inequality constraints in the lifted space at least at a point of origin of the lifted space;
transforming the objective function of the original QP into a quadratic objective function involving variables of the original QP and the additional non-negative variable, wherein the quadratic objective function subject to the lifted equality and inequality constraints forms a homogeneous QP in the lifted space such that first-order optimality conditions of the homogeneous QP correspond to first-order optimality conditions of the original QP lifted in the higher space by the lifting operation;
solving the homogeneous QP to produce a solution in the lifted space using a decomposition that replaces variables corresponding to individual generators with dual variables corresponding to the total demand of power, the additional nonnegative variable, and a dual variable corresponding to the additional nonnegative variable;
controlling the electric grid according to an infeasibility protocol when a value of the additional non-negative variable in the solution in the lifted space equals zero; and otherwise
projecting the solution in the lifted space into the original space using a projection operation reversing the lifting operation to produce a solution of the original QP; and
controlling the electric grid using a control command determined based on the solution of the original QP.
